(19) United States
(12) Patent Application Publication
(10) Pub. No.: US 2014/0232082 A1
(43) Pub. Date: Aug. 21, 2014

(54) SUSPENSION SYSTEM

(71) Applicants: Morito Oshita, Kariya-shi (JP); Fumio Kojima, Kariya-shi (JP); Kosuke Sakai, Kariya-shi (JP); Yoshifumi Ohtani, Kariya-shi (JP)

(72) Inventors: Morito Oshita, Kariya-shi (JP); Fumio Kojima, Kariya-shi (JP); Kosuke Sakai, Kariya-shi (JP); Yoshifumi Ohtani, Kariya-shi (JP)

(73) Assignee: AISIN SEIKI KABUSHIKI KAISHA, Kariya-shi (JP)

(21) Appl. No.: 14/347,829

(22) PCT Filed: Sep. 6, 2012
(86) PCT No.: PCT/JP2012/072745

§ 371 Date: Mar. 27, 2014

(30) Foreign Application Priority Data
Sep. 27, 2011 (JP) 2011-210702
Sep. 27, 2011 (JP) 2011-210703
Aug. 6, 2012 (JP) 2012-174319

(51) Int. Cl. B60G 17/016

(52) U.S. Cl. CPC B60G 17/0164
USPC 280/124.161

(57) ABSTRACT

A suspension system includes an upper cylinder chamber, a lower cylinder chamber, and a variable valve that adjusts the opening area of an opening of the lower cylinder chamber. The suspension system includes a first communication path through which the upper cylinder chamber of one of damping force control cylinders incorporated in a pair of wheels of a vehicle is in communication with the lower cylinder chamber of the other damping force control cylinder, a second communication path through which the lower cylinder chamber of the one damping force control cylinder is in communication with the upper cylinder chamber of the other damping force control cylinder, and a pair of oil receptacles that are provided in the first and second communication paths, respectively, and hold and discharge oil, depending on operations of the damping force control cylinders.

### TECHNICAL FIELD

The present invention relates to suspension systems for improving the ride quality and maneuvering stability of vehicles.

### BACKGROUND ART

Vehicles are traditionally equipped with a suspension in order to improve ride quality and maneuvering stability. The suspension includes a spring for supporting the weight of the vehicle and absorbing shocks, and a shock absorber for damping the vibration of the spring, and buffers shocks from a road surface. Techniques relating to such a suspension are described in, for example, Patent Documents 1 and 2 identified below.

Patent Document 1 describes a vehicle roll damping force control device that includes a damping force generation mechanism and a front and rear roll damping force control means. The damping force generation mechanism, which is provided between each front wheel and the vehicle body and between each rear wheel and the vehicle body, generates a damping force that is proportional to the roll angular speed of the vehicle body. Specifically, at each of the front and rear wheel pairs, an upper cylinder chamber of a left-wheel hydraulic cylinder is connected through a hydraulic pipe to a lower cylinder chamber of a right-wheel hydraulic cylinder, and a lower cylinder chamber of the left-wheel hydraulic cylinder is connected through another hydraulic pipe to an upper cylinder chamber of the right-wheel hydraulic cylinder. As a result, the two cylinders are cross-linked by the pipes. The hydraulic pipes each have a variable throttle valve. The front and rear roll damping force control means controls the damping force generation mechanism so that damping forces exerted on the front and rear wheels increase with an increase in vehicle speed, and the ratio of the damping force exerted on the front wheel to the damping force exerted on the rear wheel increases with an increase in steering angular speed.

Patent Document 2 describes a vehicle shake damping device that includes: shock absorbers that are provided between a left wheel and the vehicle body and between a right wheel and the vehicle body, respectively. In addition to the shock absorbers, the vehicle shake damping device includes a damping mechanism including: a left hydraulic cylinder that is provided between the left wheel and the vehicle body, separately from the shock absorber; a right hydraulic cylinder that is provided between the right wheel and the vehicle body; a first fluid path that connects an upper cylinder chamber of the left hydraulic cylinder and a lower cylinder chamber of the right hydraulic cylinder together in communication with each other; a second fluid path that connects an upper cylinder chamber of the right hydraulic cylinder and a lower cylinder chamber of the left hydraulic cylinder together in communication with each other; a third fluid path that connects the first fluid path and a reservoir tank together in communication with each other; a fourth fluid path that connects the second fluid path and the reservoir tank together in communication with each other; and variable throttles that are provided in the third and fourth fluid paths, respectively. The vehicle shake damping device also includes a control mechanism that controls the positions (opening degrees) of the variable throttles, depending on how much the wheels and the vehicle body are vertically moved relative to each other.

Patent Documents 3 to 5 identified below describe techniques relating to hydraulic cylinders included in suspension systems. Hydraulic cylinders described in Patent Documents 3 and 4 are of the twin-tube type including a slidable piston and piston rod. The volumes of two cylinder chambers separated from each other by the piston are changed by the movement of the piston. By generating the flow of oil through a port provided in the hydraulic cylinder, the stiffness of a suspension for an automobile is controlled.

A fluid pressure damper included in a suspension device described in Patent Document 5 is also of the twin-tube type including a slidable piston and piston rod. Also in this fluid pressure damper, the volume of an oil chamber (corresponding to a “cylinder chamber”) partitioned in a cylinder by a piston is changed by the movement of the piston to generate the flow of oil, whereby a change in an automobile's orientation (attitude) is reduced.

### PRIOR ART DOCUMENTS

### Patent Documents

Patent Document 1: JP H04-46815 A
Patent Document 2: JP H05-193331 A
Patent Document 3: JP 2005-133902 A
Patent Document 4: JP 2007-205416 A
Patent Document 5: JP 4740086 B

### DISCLOSURE OF INVENTION

### Problem to be Solved by the Invention

The vehicle roll damping force control device of Patent Document 1 is not equipped with any device for imparting roll stiffness other than the spring. Therefore, for example, when a vehicle turns or corners on a ramp way etc. for a long period of time, the amount of roll of the vehicle is significant, and therefore, the cornering performance unavoidably deteriorates. Although good ride quality can be ensured when in-phase bounces are input, under-spring shakes that occur due to a road force exerted on each wheel depend on a damping force initially set in the shock absorber. Therefore, optimum road holding or ride quality cannot be invariably ensured.

Also, a damping force in the roll direction at the front and rear wheels during turning or cornering can be controlled using the variable throttle valve provided in the hydraulic pipe. However, when a relatively great road force exerted on a single wheel causes an input force that tries to move the vehicle body in the roll direction, the vehicle body is directly shaken and therefore ride quality and driving stability unavoidably deteriorate.

Also, a vehicle speed sensor and a steering angle sensor are used to control the front and rear damping force valves and thereby change the absolute values or ratio of front and rear roll dampings, whereby understeer and oversteer are reduced or avoided. However, neutral steer cannot be ensured during turning or cornering.

In the vehicle suspension device described in Patent Document 2, the shock absorber and the damping mechanism are arranged side by side, and therefore, the structure around the wheel is disadvantageously complicated. Moreover, it is necessary to detect the relative vertical movement (an amount, speed, etc.) of the wheel and the vehicle body, and based on the result of the detection, control the damping mechanism. Therefore, it is likely to disadvantageously take a lot of time and effort to control the device.

In the hydraulic cylinders described in Patent Documents 3 and 4, the cylinder outer tube and the port are integrally formed. On the other hand, in the fluid pressure damper of Patent Document 5, the rod has an internal hollow space that is used as a fluid path. Therefore, it is necessary to connect a pipe to the outer tube of the cylinder, and therefore, when the cylinder is mounted in a vehicle, it is necessary to provide any one of the pipe or the rod, and a dust seal portion, in a lower portion of the vehicle. Therefore, the pipe or the rod, and the dust seal portion are likely to be degraded or damaged due to thrown-up stones, dust, mud, etc.

With the above problems in mind, it is an object of the present invention to provide a suspension system that can provide optimum ride quality and driving stability irrespective of conditions under which a vehicle travels.

### Means for Solving Problem

In order to achieve the above object, a suspension system according to the present invention has the following characteristic configuration including:

damping force control cylinders each including an upper cylinder chamber whose volume increases during expansion and decreases during contraction, a lower cylinder chamber whose volume decreases during expansion and increases during contraction, and a variable valve that adjusts the flow rate of oil flowing out of the lower cylinder chamber based on the result of detection performed by a detector that detects a physical quantity of a vehicle, wherein the damping force control cylinders are incorporated in a pair of wheels of a plurality of wheels included in the vehicle;

a first communication path through which the upper cylinder chamber of one of the damping force control cylinders is in communication with the lower cylinder chamber of the other of the damping force control cylinders;

a second communication path through which the lower cylinder chamber of the one damping force control cylinder is in communication with the upper cylinder chamber of the other damping force control cylinder; and

a pair of oil receptacles that are provided in the first and second communication paths, respectively, and hold and discharge oil of the first and second communication paths, depending on operations of the damping force control cylinders.

With this characteristic configuration, a damping force in the expansion direction of the suspension can be optimized, and therefore, road holding on a road surface can be improved. Therefore, in the pair of wheels in which a pair of the damping force control cylinders are incorporated, a motion of the vehicle body can be reduced by controlling the damping force. Therefore, optimum ride quality and driving stability can be achieved irrespective of conditions under which the vehicle travels.

Also, an acceleration detector is preferably provided that detects an acceleration in a direction perpendicular to a vehicle body of the vehicle. The variable valve preferably adjusts the flow rate of the oil based on the result of the detection performed by the acceleration detector.

With this configuration, the damping force of the suspension can be adjusted, depending on conditions under which the vehicle travels, whereby ride quality can be improved. Therefore, optimum driving stability can be achieved.

Also, the oil receptacle is preferably an accumulator.

With this configuration, the flow rates of oil of the first and second communication paths can be suitably maintained.

Also, a variable valve is preferably provided that limits the flow rate of oil flowing into the accumulator.

With this configuration, the accumulator can suitably hold and discharge oil of the first and second communication paths.

Also, a check valve is preferably provided in parallel with the variable valve that limits the flow rate of oil flowing into the accumulator.

With this configuration, while the check valve does not allow oil to flow into the accumulator, the variable valve allows oil to smoothly flow out of the accumulator. Therefore, the pressures of the first and second communication paths can each be suitably adjusted.

Also, the pair of wheels are preferably a left wheel and a right wheel that face each other in the lateral direction of the vehicle.

With this configuration, different loads on the left and right sides of the vehicle can be suitably damped. Therefore, optimum ride quality and driving stability can be achieved.

Alternatively, the pair of wheels are preferably a front wheel and a rear wheel that are arranged in the longitudinal direction of the vehicle.

With this configuration, different loads on the front and rear sides of the vehicle can be suitably damped. Therefore, optimum ride quality and driving stability can be achieved.

Also, a left hydraulic cylinder interposed between the left wheel and a vehicle body, and a right hydraulic cylinder interposed between the right wheel and the vehicle body, preferably have ports through which oil is supplied to and discharged from the upper and lower cylinder chambers, the ports being preferably separated from a lower fixing member.

With this configuration, the suspension system can be less affected by stones or mud thrown up by the traveling vehicle. Therefore, durability and reliability can be improved.

Also, the port through which oil of the upper cylinder chamber is supplied and discharged, and the port through which oil of the lower cylinder chamber is supplied and discharged, are preferably provided in an upper fixing member of a rod.

With this configuration, the influence of stones or mud thrown up by the traveling vehicle can be eliminated. Therefore, durability and reliability can be improved.

Also, an upper cylinder chamber fluid path through which oil of the upper cylinder chamber is supplied and discharged, and a lower cylinder chamber fluid path through which oil of the lower cylinder chamber is supplied and discharged, are preferably provided radially inside the rod.

With this configuration, the upper and lower cylinder chamber fluid paths can be protected by the rod. Therefore, it is not necessary to provide a means for improving the durability of the upper and lower cylinder chamber fluid paths, and therefore, an increase in cost can be avoided.

Also, a tube-shaped member is preferably provided radially inside the rod, the tube-shaped member and the rod having the same central axis, the lower cylinder chamber fluid path is preferably formed radially inside the tube-shaped member, and the upper cylinder chamber fluid path is preferably formed between the inner circumferential surface of the rod and the outer circumferential surface of the tube-shaped member.

With this configuration, the upper and lower cylinder chamber fluid paths can be formed only by arranging cylinders having different diameters in a concentric manner. Therefore, the upper and lower cylinder chamber fluid paths can be formed using a simple structure.

### BRIEF DESCRIPTION OF DRAWINGS

FIG. 1 is a diagram schematically showing a vehicle in which a suspension system according to a first embodiment is mounted.

FIG. 2 is a diagram showing roll stiffness imparted by an accumulator.

FIG. 3 is a diagram showing an example case where a single front wheel of the vehicle including the suspension system of the first embodiment is on a bump.

FIG. 4 is a diagram showing an example case where a single front wheel of the vehicle including the suspension system of the first embodiment is on a bump.

FIG. 5 is a diagram showing an example case where the vehicle including the suspension system of the first embodiment turns or corner left.

FIG. 6 is a diagram showing an example case where the vehicle including the suspension system of the first embodiment turns or corner left.

FIG. 7 is a flowchart showing a control that is performed when a road force is exerted on a single wheel of the vehicle including the suspension system of the first embodiment.

FIG. 8 is a flowchart showing a control that is performed when the vehicle including the suspension system of the first embodiment turns or corners.

FIG. 9 is a diagram schematically showing a test travel pattern.

FIG. 10 is a diagram showing a difference in travel characteristics between the presence and absence of the suspension system.

FIG. 11 is a diagram showing a difference in travel characteristics between the presence and absence of the suspension system.

FIG. 12 is a diagram showing a difference in travel characteristics between the presence and absence of the suspension system.

FIG. 13 is a diagram schematically showing a vehicle in which a suspension system according to a second embodiment is mounted.

FIG. 14 is a diagram schematically showing a vehicle in which a suspension system according to a third embodiment is mounted.

FIG. 15 is a diagram showing an example where the brakes are put on the vehicle including the suspension system of the third embodiment.

FIG. 16 is a diagram showing an example where the brakes are put on the vehicle including the suspension system of the third embodiment.

FIG. 17 is a diagram showing an example where the vehicle including the suspension system of the third embodiment starts moving or accelerates.

FIG. 18 is a diagram showing an example where the vehicle including the suspension system of the third embodiment starts moving or accelerates.

FIG. 19 is a diagram showing an example where the vehicle including the suspension system of the third embodiment turns or corners right.

FIG. 20 is a diagram showing an example where the vehicle including the suspension system of the third embodiment turns or corners right.

FIG. 21 is a diagram schematically showing a vehicle in which a suspension system according to a fourth embodiment is mounted.

FIG. 22 is a diagram for describing a relationship between pressures and flow rates of a damping force valve.

FIG. 23 is a diagram for describing a relationship between piston speeds and damping forces.

FIG. 24 is a schematic diagram showing an action of the suspension system of the fourth embodiment.

FIG. 25 is a schematic diagram showing an action of the suspension system of the fourth embodiment.

FIG. 26 is a schematic diagram showing an action of the suspension system of the fourth embodiment.

FIG. 27 is a schematic diagram showing a suspension system according to a fifth embodiment.

FIG. 28 is a schematic diagram showing an action of the suspension system of the fifth embodiment.

FIG. 29 is a schematic diagram showing an action of the suspension system of the fifth embodiment.

FIG. 30 is a schematic diagram showing an action of the suspension system of the fifth embodiment.

FIG. 31 is a schematic diagram showing an action of the suspension system of the fifth embodiment.

FIG. 32 is a schematic diagram showing an action of the suspension system of the fifth embodiment.

FIG. 33 is a schematic diagram showing a suspension system according to a sixth embodiment.

FIG. 34 is a schematic diagram showing a hydraulic cylinder.

FIG. 35 is a schematic diagram showing an action of a suspension system according to another embodiment.

FIG. 36 is a schematic diagram showing a hydraulic cylinder according to another embodiment.

### BEST MODE FOR CARRYING OUT THE INVENTION

### 1. Suspension System

Embodiments of the present invention will now be described in detail. A suspension system 100 according to the present invention is mounted in a vehicle and has a function of providing optimum ride quality and driving stability to a driver and passengers on the vehicle.

### 1-1. First Embodiment

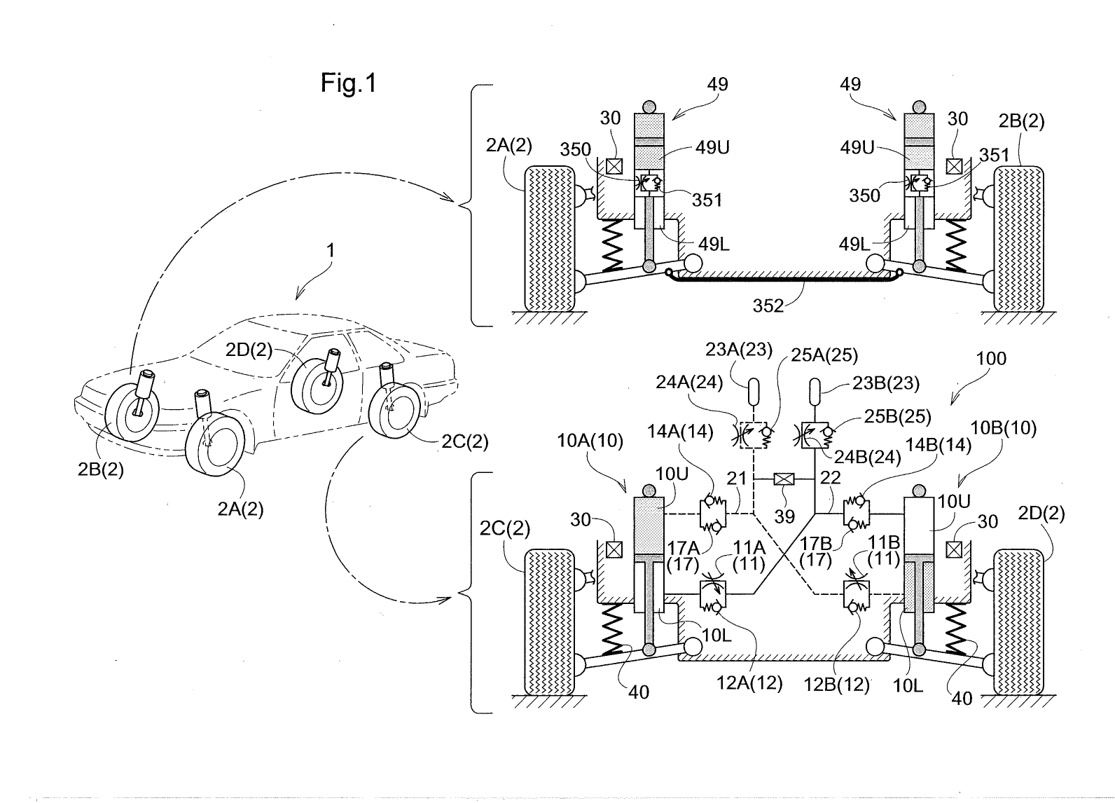

A first embodiment of the suspension system 100 will be described. FIG. 1 schematically shows the suspension system 100 of this embodiment mounted in a vehicle 1. The suspension system 100 includes damping force control cylinders 10, a first communication path 21, a second communication path 22, and oil receptacles 23.

The damping force control cylinders 10 are incorporated in a pair of wheels 2 of a plurality of wheels 2 possessed by the vehicle 1. The plurality of wheels 2 are a left front wheel 2A, a right front wheel 2B, a left rear wheel 2C, and a right rear wheel 2D of the vehicle 1. The pair of wheels 2 are a left wheel and a right wheel facing each other in the lateral direction of the vehicle 1. In this embodiment, there are a pair of the damping force control cylinders 10, which incorporated in the left and right rear wheels 2C and 2D, respectively. In this embodiment, when it is hereinafter particularly necessary to distinguish the damping force control cylinders 10 from each other, the damping force control cylinder 10 incorporated in the left rear wheel 2C is indicated by a reference character 10A, and the damping force control cylinder 10 incorporated in the right rear wheel 2D is indicated by a reference character 10B.

The damping force control cylinder 10 includes an upper cylinder chamber 10U, a lower cylinder chamber 10L, and a variable valve 11, which form an expandable cylinder damper. The upper cylinder chamber 10U is configured so that the volume thereof increases as the cylinder damper expands, and decreases as the cylinder damper contracts. The lower cylinder chamber 10L is configured so that the volume thereof decreases as the cylinder damper expands, and increases as the cylinder damper contracts.

The variable valve 11 adjusts the flow rate of oil R flowing out of the lower cylinder chamber 10L based on the result of detection performed by a detector that detects a physical quantity of the vehicle. As described above, there are a pair of the damping force control cylinders 10. Therefore, there are a pair of the variable valves 11, i.e., 11A and 11B. The pair of variable valves 11A and 11B are configured to separately adjust the flow rates of the oil R flowing out of the respective lower cylinder chambers 10L. In other words, the variable valves 11A and 11B can adjust the flow rates of the oil R to different values.

Each lower cylinder chamber 10L has an opening (not shown). The variable valve 11 is connected to the opening so that the variable valve 11 is in communication with the lower cylinder chamber 10L. The variable valve 11 is configured so that the opening area thereof can be changed by an electrical control. Specifically, the opening area is changed based on a signal from a controller (not shown). As a result, the variable valve 11 can limit the flow rate of the oil R flowing out of the lower cylinder chamber 10L. Note that the variable valve 11 also allows the oil R to flow into the lower cylinder chamber 10L.

A check valve 12 is provided in parallel with the variable valve 11. As described above, there are a pair of the variable valves 11, i.e., 11A and 11B. Therefore, there are a pair of the check valves 12, i.e., the check valve 12A that is provided in parallel with the variable valve 11A and the check valve 12B that is provided in parallel with the variable valve 11B. The check valve 12 operates so that the oil R is not allowed to flow out of the lower cylinder chamber 10L and is allowed to smoothly flow into the lower cylinder chamber 10L.

Each upper cylinder chamber 10U has an opening (not shown). A damping force valve 14 (14A, 14B) for generating a damping force when the oil R flows out (contraction), and a check valve 17 (17A, 17B) for allowing the oil R to smoothly flow in (expansion), are connected to the opening so that the damping force valve 14 and the check valve 17 are in communication with the upper cylinder chamber 10U. The check valve 17A is configured to be opened against a force that a spring exerts so that the oil R flows only in a direction opposite to that in which the damping force valve 14A allows the oil R to flow. Similarly, the check valve 17B is configured to be opened against a force that a spring exerts so that the oil R flows only in a direction opposite to that in which the damping force valve 14B allows the oil R to flow. Therefore, the oil R flows into and out of each upper cylinder chamber 10U through different paths.

The first communication path 21 allows the upper cylinder chamber 10U of the damping force control cylinder 10A on one side and the lower cylinder chamber 10L of the damping force control cylinder 10B on the other side to be in communication with each other. Specifically, the upper cylinder chamber 10U of the damping force control cylinder 10A is in communication with the first communication path 21 through the check valve 17A and the damping force valve 14A. The lower cylinder chamber 10L of the damping force control cylinder 10B is in communication with the first communication path 21 through the variable valve 11B and the check valve 12B.

The second communication path 22 allows the lower cylinder chamber 10L of the damping force control cylinder 10A on one side and the upper cylinder chamber 10U of the damping force control cylinder 10B on the other side to be in communication with each other. Specifically, the lower cylinder chamber 10L of the damping force control cylinder 10A is in communication with the second communication path 22 through the variable valve 11A and the check valve 12A. The upper cylinder chamber 10U of the damping force control cylinder 10B is in communication with the second communication path 22 through the check valve 17B and the damping force valve 14B.

The oil receptacles 23 are provided in the first and second communication paths 21 and 22, respectively. The oil receptacles 23 hold and discharge the oil R of the first and second communication paths 21 and 22, depending on the operation of the damping force control cylinder 10. Therefore, there are a pair of the oil receptacles 23, i.e., the oil receptacle 23A that is in communication with the first communication path 21 and the oil receptacle 23B that is in communication with the second communication path 22. In this embodiment, the oil receptacle 23 includes an accumulator. The accumulator can impart roll stiffness to the vehicle. The accumulator's container is filled with a gas, and therefore, when the volume of the oil R in the accumulator's container changes, the volume of the gas changes. As a result, the accumulator acts as a gas spring. Specifically, when the oil R flows into the accumulator, the gas is compressed, and the gas spring's force (restoring force) is exerted on the oil R, whereby roll stiffness (stabilizer function) is imparted to the vehicle. In the description that follows, the oil receptacle 23 (23A, 23B) is described as the accumulator 23 (23A, 23B).

The suspension system 100 includes a variable valve 24 that limits the flow rate of the oil R flowing into the accumulator 23. As described above, there are a pair of the accumulators 23, i.e., 23A and 23B. Therefore, there are a pair of the variable valves 24, which are indicated by reference characters 24A and 24B. As with the variable valve 11, the variable valve 24 is configured so that the opening area thereof can be changed by an electrical control. Specifically, the opening area is changed based on a signal from a controller (not shown). As a result, the variable valve 24 can limit the flow rate of the oil R flowing into the accumulator 23. Note that the variable valve 24 also allows the oil R to flow out of the accumulator 23.

A check valve 25 is provided in parallel with the variable valve 24. As described above, there are a pair of the variable valves 24, i.e., 24A and 24B. Therefore, there are a pair of the check valves 25, i.e., the check valve 25A that is provided in parallel with the variable valve 24A and the check valve 25B that is provided in parallel with the variable valve 24B. The check valve 25 operates so that the oil R is allowed to smoothly flow out of the accumulator 23 without flowing into the accumulator 23. Therefore, the oil R flows out of the accumulator 23 through the check valve 25. On the other hand, the oil R flows into the accumulator 23 only through the variable valve 24. As a result, the pressure of each of the first and second communication paths 21 and 22 can be adjusted.

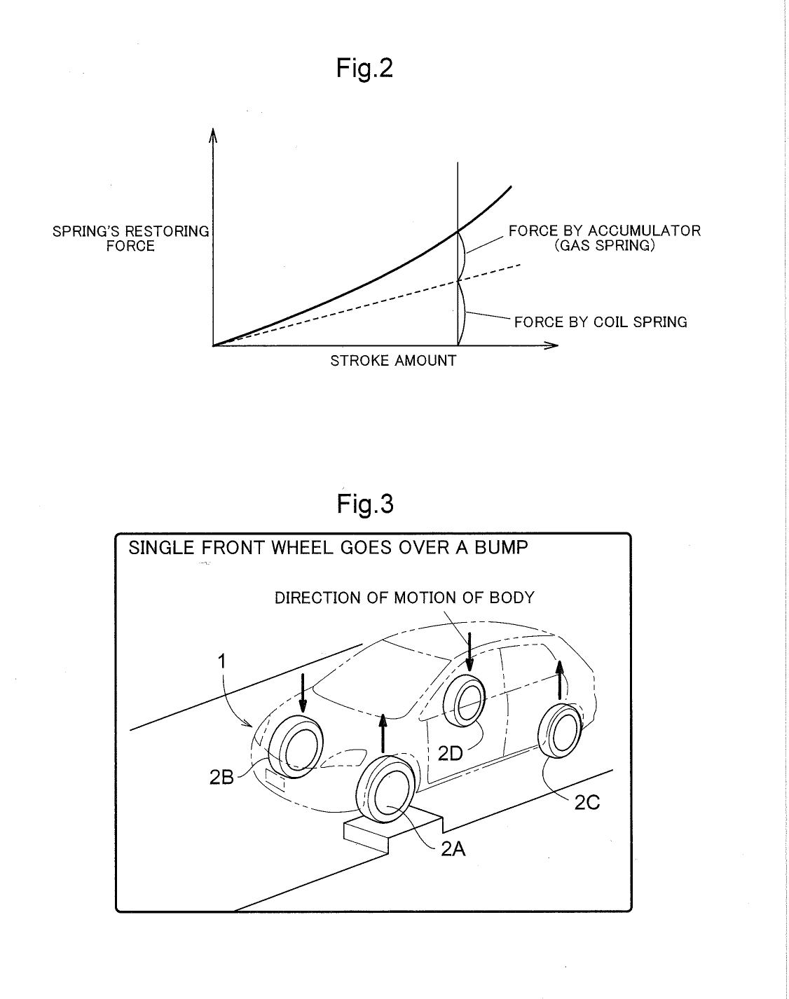

An effect of the accumulator 23 is shown in FIG. 2. In FIG. 2, the vertical axis represents a spring's restoring forces, and the horizontal axis represents stroke amounts. In FIG. 2, a dashed line indicates characteristics that are obtained when a spring 40 is used, and a solid line indicates characteristics that are obtained when both the spring 40 and the accumulator 23 are used. As shown in FIG. 2, when the accumulator 23 is used, an effect similar to that of a stabilizer is obtained when the vehicle rolls.

Although not shown, a communication path is provided in the variable valve 24 at an orifice's level in parallel with the variable valve 24 and the check valve 25. The communication path allows the accumulator 23 and the first and second communication paths 21 and 22 to be invariably in communication with each other. The communication path can also impart a damping force characteristic during the low-speed stroke of the cylinder.

Referring back to FIG. 1, the vehicle 1 includes an acceleration detector 30 that detects an acceleration of the vehicle 1 in a direction perpendicular to the vehicle body. The result of the detection by the acceleration detector 30 is transferred to a controller (not shown). The controller adjusts the flow rate of the oil R flowing out of the lower cylinder chamber 10L based on the detection result of the acceleration detector 30. Therefore, in this embodiment, the “detector” described above corresponds to the “acceleration detector 30.”

A communication mechanism 39 causes the first and second communication paths 21 and 22 to be or not to be in communication. The communication mechanism 39 may have either a mechanical configuration or an electromagnetic configuration, which does not have an influence on suspension performance based on travel of the vehicle 1 described below. When, for example, the vehicle 1 leans due to an increase or decrease in the volume of the oil R caused by internal leakage of the oil R from a hydraulic circuit including the first communication path 21 and a hydraulic circuit including the second communication path 22, a change in the temperature of the oil R, etc., the communication mechanism 39 causes the oil R to leak at a small flow rate between the two hydraulic circuits, thereby keeping a balance between the volumes, i.e., avoiding an unbalanced state.

On the other hand, a shock absorber 49 is incorporated in each of the left and right front wheels 2A and 2B of the vehicle 1. The pair of shock absorbers 49 each include an upper cylinder chamber 49U and a lower cylinder chamber 49L, which are in communication with each other through a variable valve 350 and a check valve 351. The shock absorber 49 is well known and therefore will not be described. Note that a known stabilizer 352 is provided between the pair of shock absorbers 49 incorporated in the left and right front wheels 2A and 2B of the vehicle 1. In this embodiment, the suspension system 100 thus configured is mounted in the vehicle 1.

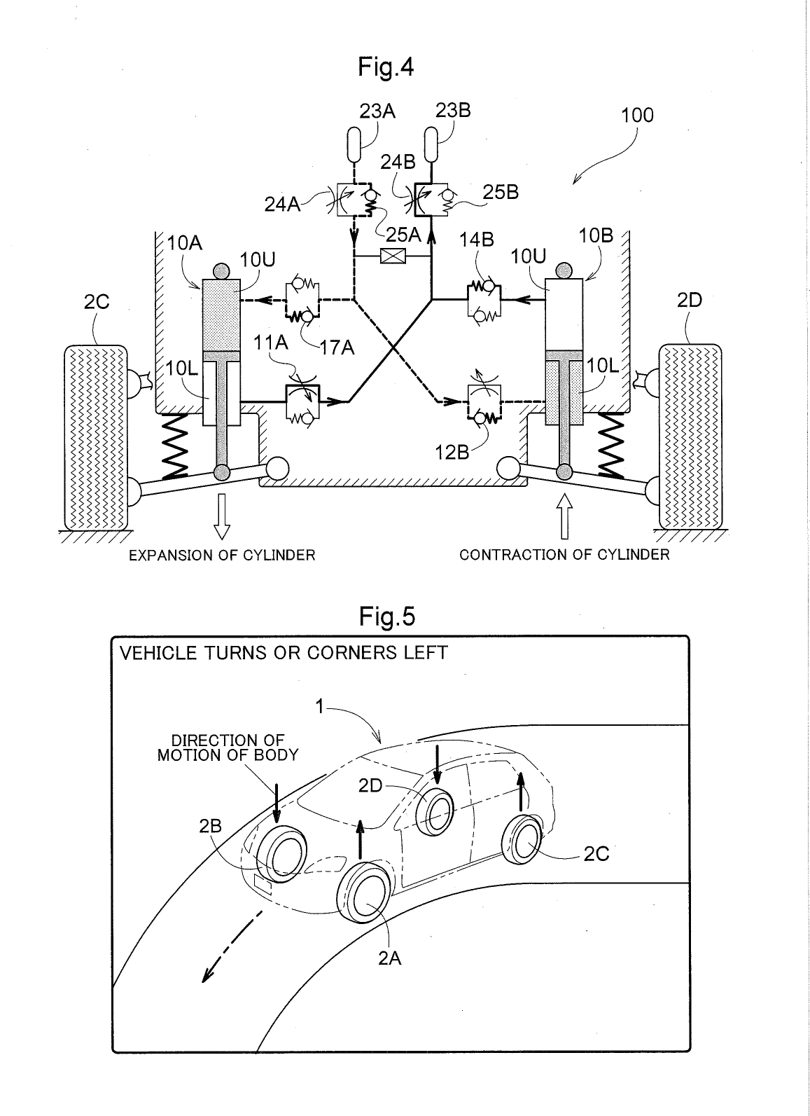

Next, an operation of the suspension system 100 will be described. For example, as shown in FIG. 3, when the left front wheel 2A of the vehicle 1 travels on a raised ground or bump (after moving thereonto), the vehicle body moves in directions indicated by arrows in FIG. 3, and relative movements occur between the wheels and the vehicle body. The damping force control cylinder 10A for the left rear wheel 2C expands in the rebound direction, and the damping force control cylinder 10B for the right rear wheel 2D contracts in the bound direction. In this case, as shown in FIG. 4, the oil R flows out of the lower cylinder chamber 10L of the damping force control cylinder 10A on one side through the variable valve 11A, and at the same time, the oil R also flows out of the upper cylinder chamber 10U of the damping force control cylinder 10B on the other side through the damping force valve 14B. These portions of the oil R flow together into the accumulator 23B through the variable valve 24B, and therefore, a great damping force is generated in the left and right damping force control cylinders 10A and 10B. At this time, the oil R smoothly flows into the upper cylinder chamber 10U of the damping force control cylinder 10A and the lower cylinder chamber 10L of the damping force control cylinder 10B from the accumulator 23A through the check valves (the check valve 25A, the check valve 17A, and the check valve 12B) of the ports.

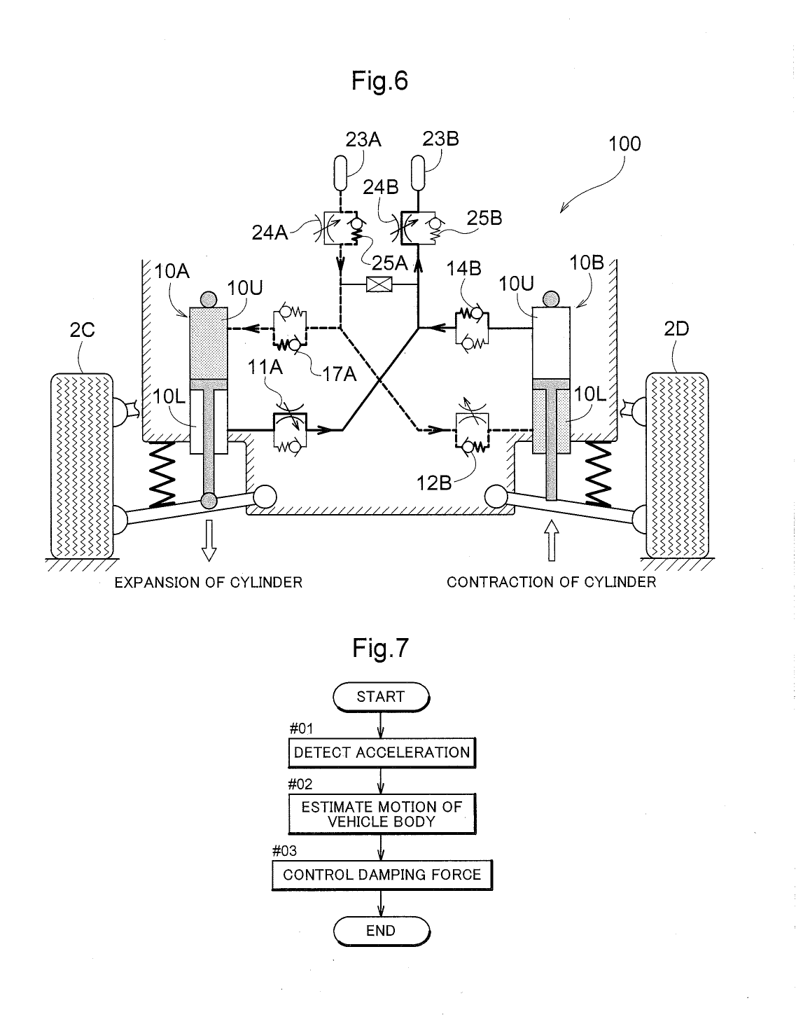

Moreover, for example, as shown in FIG. 5, when the vehicle 1 is traveling while turning or cornering left, an upward load is exerted on the left side of the vehicle 1, and a downward load is exerted on the right side of the vehicle 1. In this case, as shown in FIG. 6, the oil R flows out of the lower cylinder chamber 10L of the damping force control cylinder 10A through the variable valve 11A, and at the same time, flows out of the upper cylinder chamber 10U of the damping force control cylinder 10B through the damping force valve 14B. These portions of the oil R flow into the accumulator 23B through the variable valve 24B.

Also, the oil R smoothly flows into the upper cylinder chamber 10U of the damping force control cylinder 10A on one side through the check valve 17A, and at the same time, smoothly flows into the lower cylinder chamber 10L of the damping force control cylinder 10B on the other side through the check valve 12B. These portions of the oil R correspond to that which has flowed out of the accumulator 23A through the check valve 25A.

At this time, a great damping force is exerted on the damping force control cylinder 10A by the variable valve 11A for the lower cylinder chamber 10L of the damping force control cylinder 10A and the variable valve 24B for the accumulator 23B. On the other hand, a great damping force is exerted on the damping force control cylinder 10B by the damping force valve 14B and the variable valve 24B for the accumulator 23B.

As a result, the suspension system 100 functions as a suspension having a damping force control. When the vehicle 1 normally travels straight ahead, in a large curve, etc., a motion of the vehicle body caused by an under-spring input force (shake) from a road surface is estimated by the acceleration detector 30 provided in the vehicle 1 to optimally control a damping force in the expansion direction of each wheel. As a result, the shakes of the wheels 2 are reduced to improve road holding, whereby sufficient ride quality and driving stability are ensured.

FIG. 7 shows a flow of a process that is performed by the controller when a component in the roll direction of a road force exerted on a single front wheel is exerted on the vehicle 1. For example, when a component in the roll direction of a road force exerted on a single front wheel is exerted on the vehicle 1 (step #01), a motion of the vehicle body caused by the force input from a road surface is estimated based on the result of detection performed by the acceleration detector 30 (step #02), and a damping force of the variable valve 11 for the rear wheel is controlled to reduce the motion of the vehicle body (step #03). As a result, ride quality can be improved. Specifically, when an input force is exerted on the right front wheel 2B in the bound direction, the reaction force (load) is exerted on a right front portion of the vehicle body in a direction perpendicular to the vehicle body, so that the vehicle body is moved upward, and at the same time, the vehicle body is generally relatively moved in the roll direction. The motion of the vehicle body is estimated based on the result of detection performed by the acceleration detector 30 mounted in the vehicle 1, to control the variable valve 11 for the rear wheel to increase the roll damping force, thereby reducing the motion of the vehicle body.

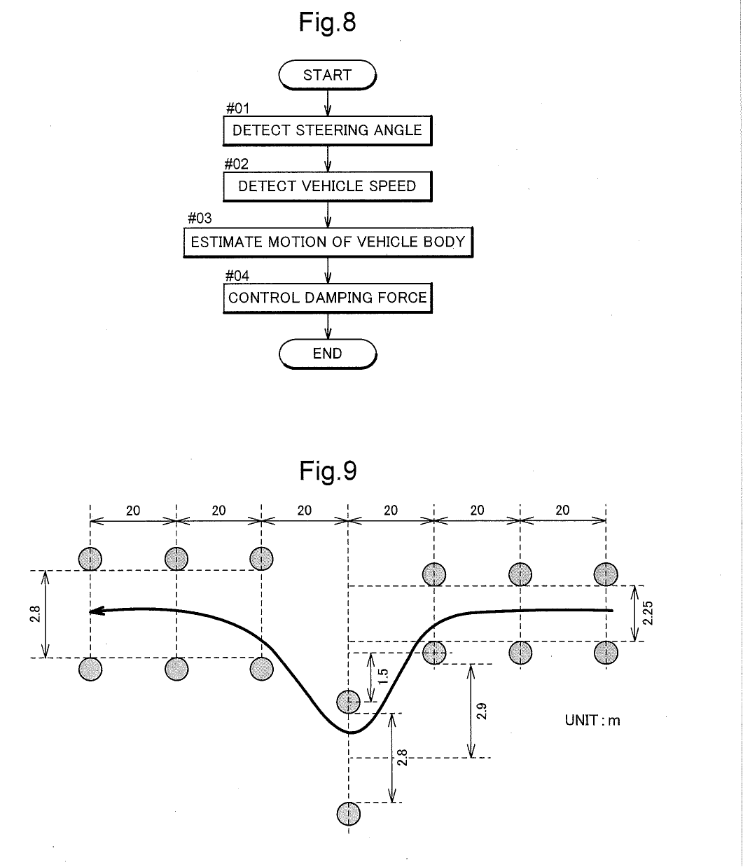

FIG. 8 shows a flow of a process that is performed by the controller when a roll direction component force is exerted on the vehicle 1 when the vehicle 1 turns or corners. If a lateral acceleration that is greater than or equal to a predetermined value occurs when the vehicle 1 turns or corners, a motion of the vehicle body is estimated (step #03) based on the result of detection (step #01) performed by the steering angle sensor and the result of detection (step #02) performed by the vehicle speed sensor, and the damping forces of the variable valves 11 and 24 for the rear wheel are controlled to provide neutral steer in which yaw and lateral G are synchronous with each other (step #04), whereby roll stiffness allocations are changed, and therefore, agility and vehicle stability during turning or cornering are improved. Also, with this configuration, in addition to roll stiffness provided by the spring 40, roll stiffness based on a supply pressure from the accumulator 23 can be imparted only when the vehicle rolls. Therefore, even when the vehicle continues to turn or corner for a relatively long period of time, roll can be reduced to a predetermined amount or less. Therefore, vehicle stability can be improved.

Next, an effect of the suspension system 100 will be described using data that is obtained when the vehicle 1 having the suspension system 100 travels. A travel pattern of the vehicle 1 is shown in FIG. 9. Three pairs (rows) of pylons separated by a distance of 2.25 m from each other are arranged at intervals of 20 m. A fourth pair (row) of pylons separated by a distance of 2.8 m from each other are provided at a distance of 20 m in the travel direction from the third row of pylons, with the center between the pylons being located at a distance of 2.9 m from a left end of the left pylon in the third row as viewed in the travel direction. Fifth to seventh pairs (rows) of pylons separated by a distance of 2.8 m from each other are arranged at intervals of 20 m, with the center between pylons of each pair coincides with the center between pylons of each of the first to third rows.

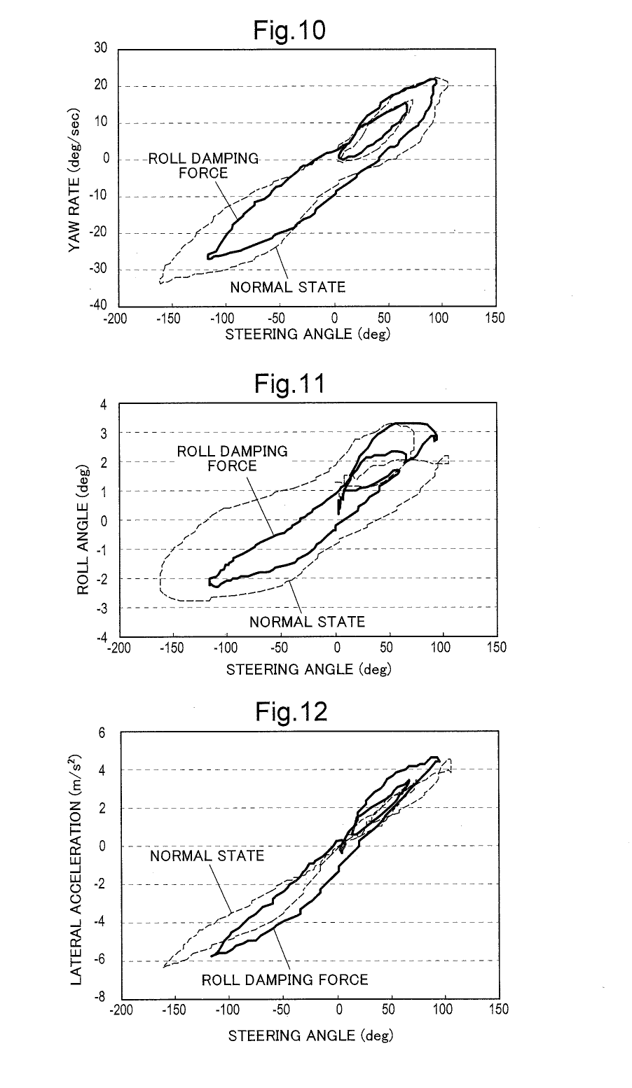

FIGS. 10-12 show a relationship between steering angles and yaw rates, a relationship between steering angles and roll angles, and a relationship between steering angles and lateral accelerations, which are obtained when the vehicle 1 travels in the above travel pattern. Note that, for comparison, characteristics that are obtained in the absence of the suspension system 100 are shown by a dashed line, and characteristics that are obtained in the presence of the suspension system 100 are shown by a solid line. As shown in FIG. 10, the yaw is stable with respect to the steering angle in the presence of the suspension system 100. As shown in FIG. 11, the roll orientation (attitude) is also stable with respect to the steering angle in the presence of the suspension system 100. Moreover, as shown in FIG. 12, the lateral acceleration quickly rises with respect to the steering angle in the presence of the suspension system 100. Thus, driving stability and agility are improved in the presence of the suspension system 100.

Thus, in the suspension system 100, when the vehicle 1 normally travels straight ahead, in a large curve, etc., i.e., the lateral acceleration is small, a state of the vehicle body is detected based on the result of detection performed by the acceleration detector 30 provided on the vehicle body, and damping forces exerted on each wheel by expansion of the damping force control cylinder 10 is controlled, whereby ride quality can be improved. Also, when a roll direction component of a road force exerted on a single front wheel is exerted on the vehicle 1, the variable valves 11 and 24 for the rear wheel function as a damping force variable valve to control a damping force, thereby reducing a motion of the vehicle body. Moreover, when the vehicle 1 turns or corners to cause a lateral acceleration, the damping force of the variable valves 11 and 24 for the rear wheel is controlled using the steering angle sensor and the vehicle speed sensor so that neutral steer is achieved where yaw and lateral acceleration are synchronous with each other. Thus, by allocating different amounts of roll stiffness to the front and rear portions of the vehicle 1, the vehicle 1 is invariably allowed to turn or corner in an ideal fashion.

### 1-2. Second Embodiment

Next, a second embodiment of the suspension system 100 will be described. In the above-described first embodiment, the suspension system 100 is provided for the rear wheels, and the stabilizer 352 is provided for the front wheels. This embodiment is different from the first embodiment in that the suspension system 100 is also provided for the front wheels.

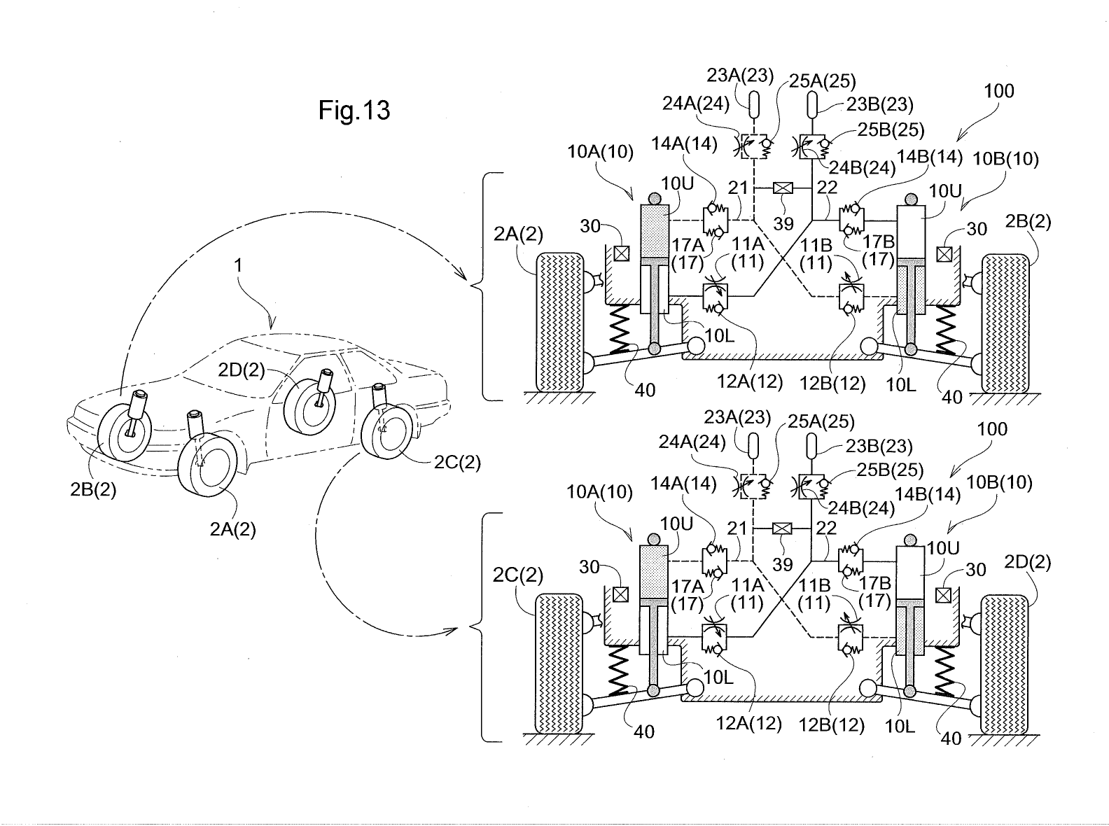

FIG. 13 is a diagram schematically showing a vehicle 1 including the suspension system 100 of this embodiment. As shown in FIG. 13, the suspension system 100 for the rear wheels is similar to that of the first embodiment. The suspension system 100 for the front wheels is similar to that for the rear wheels. Therefore, the operation and function are similar to those of the first embodiment and will be briefly described hereinafter.

In the suspension system 100 of this embodiment, the left and right upper cylinder chambers 10U and the left and right lower cylinder chambers 10L of the damping force control cylinders 10 for each of the front and rear wheel pairs are cross-linked. By providing the suspension system 100 for both the front and rear wheel pairs, the effect can be further improved compared to the suspension system 100 of the first embodiment. For example, when an input force (road force) is exerted on the right front wheel 2B in the bound direction, the reaction force (load) is exerted on a front right portion of the vehicle body in a direction perpendicular to the vehicle body, and therefore, the vehicle body moves upward and generally relatively moves in the roll direction. The motion of the vehicle body is estimated based on the result of detection performed by the acceleration detector 30 mounted in the vehicle 1, to control the variable valves 11 and 24 for both of the front and rear wheel pairs so that the roll damping force is increased, whereby the motion of the vehicle body is further reduced.

If a predetermined lateral acceleration or more occurs when the vehicle 1 turns or corners, the damping forces of the variable valves 11 and 24 for both of the front and rear wheel pairs are controlled to achieve neutral steer where yaw and lateral G are synchronous with each other, based on the result of detection performed by a steering angle sensor and the result of detection performed by a vehicle speed sensor, whereby roll stiffness allocations are changed, and therefore, agility and vehicle stability during turning or cornering are improved. Also, with this configuration, in addition to roll stiffness caused by the spring, roll stiffness based on a pressure supplied from the accumulator 23 can be added only during roll. Therefore, even when the vehicle 1 continues to turn or corner for a relatively long period of time, roll can be reduced at both of the front and rear wheel pairs. Therefore, vehicle stability can be further improved.

### 1-3. Third Embodiment

Next, a third embodiment of the suspension system 100 will be described. In the above-described first and second embodiments, the suspension system 100 is provided between the left and right wheels facing each other in the lateral direction of the vehicle 1. This embodiment is different from the first and second embodiments in that the suspension system 100 is provided between the front and rear wheels in the longitudinal direction of the vehicle 1. Differences will now be mainly described.

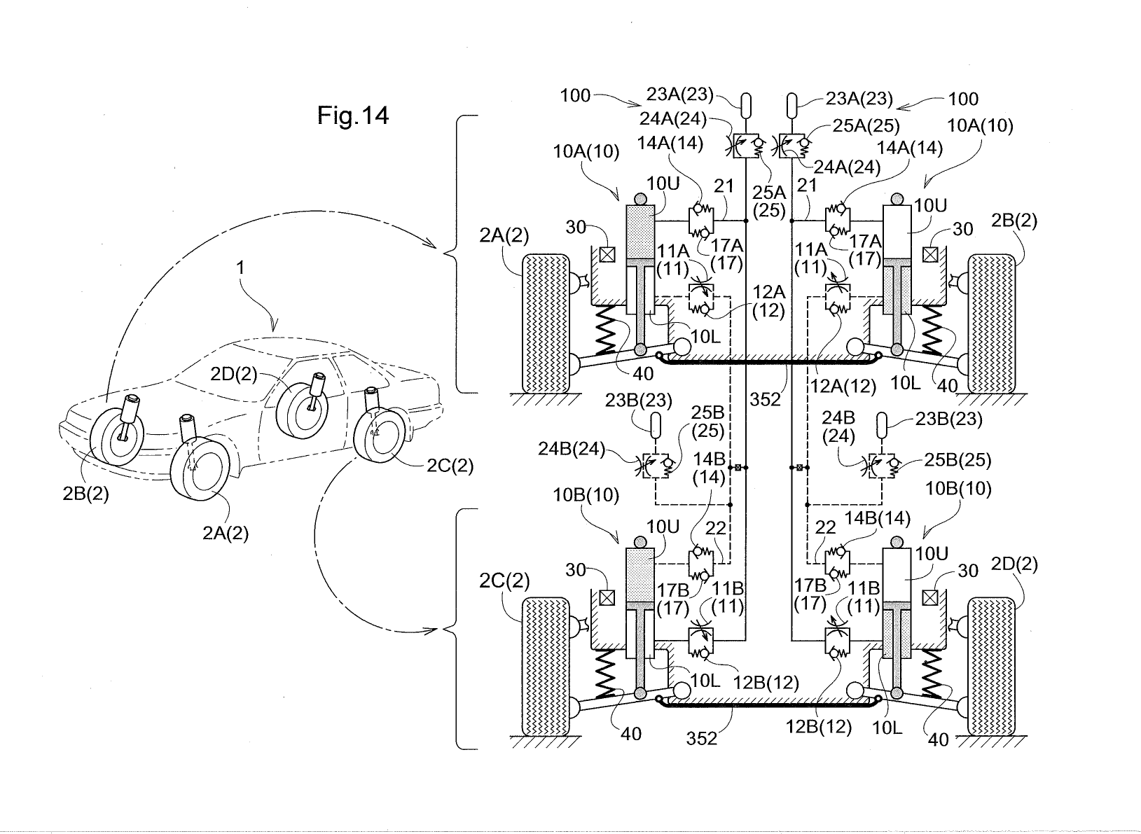

FIG. 14 schematically shows the suspension system 100 of this embodiment mounted in the vehicle 1. A damping force control cylinder 10 possessed by the suspension system 100 of this embodiment is incorporated in each pair of wheels 2 of a plurality of wheels 2 possessed by the vehicle 1. The plurality of wheels 2 are a left front wheel 2A, a right front wheel 2B, a left rear wheel 2C, and a right rear wheel 2D of the vehicle 1. Each pair of wheels 2 are a front wheel and a rear wheel arranged in the longitudinal direction of the vehicle 1. Therefore, there are one pairs of the damping force control cylinders 10. In this embodiment, one pair is provided for the left front and rear wheels 2A and 2C, and the other pair is provided for the right front and rear wheels 2B and 2D.

In the description that follows, when it is particularly necessary to distinguish the damping force control cylinders 10 from each other, the damping force control cylinders 10 incorporated in the left and right front wheels 2A and 2B are indicated by a reference character 10A, and the damping force control cylinders 10 incorporated by the left and right rear wheels 2C and 2D are indicated by a reference character 10B. The suspension system 100 provided on the left side of the vehicle 1 and the suspension system 100 provided on the right side of the vehicle 1 have a similar operation and function. Therefore, the suspension system 100 provided on the left side of the vehicle 1 will now be mainly described.

The first communication path 21 of this embodiment allows the upper cylinder chamber 10U of the damping force control cylinder 10A on one side and the lower cylinder chamber 10L of the damping force control cylinder 10B on the other side to be in communication with each other. Specifically, the upper cylinder chamber 10U of the damping force control cylinder 10A incorporated in the left front wheel 2A is in communication with the first communication path 21 through the damping force valve 14A and the check valve 17A. The lower cylinder chamber 10L of the damping force control cylinder 10B incorporated in the left rear wheel 2C is in communication with the first communication path 21 through the variable valve 11B and the check valve 12B.

The second communication path 22 of this embodiment allows the lower cylinder chamber 10L of the damping force control cylinder 10A on one side and the upper cylinder chamber 10U of the damping force control cylinder 10B on the other side to be in communication with each other. Specifically, the lower cylinder chamber 10L of the damping force control cylinder 10A incorporated in the left front wheel 2A is in communication with the second communication path 22 through the variable valve 11A and the check valve 12A. The upper cylinder chamber 10U of the damping force control cylinder 10B incorporated in the left rear wheel 2C is in communication with the second communication path 22 through the damping force valve 14B and the check valve 17B.

In this embodiment, the suspension system 100 thus configured is provided in a left portion of the vehicle 1. On the other hand, the suspension system 100 having a similar configuration is provided for the right front and rear wheels 2B and 2D of the vehicle 1. Also, in the suspension system 100 of this embodiment, the stabilizer 352 is provided in each of a front portion and a rear portion of the vehicle 1, extending in the lateral direction (between a left portion and a right portion of the vehicle 1).

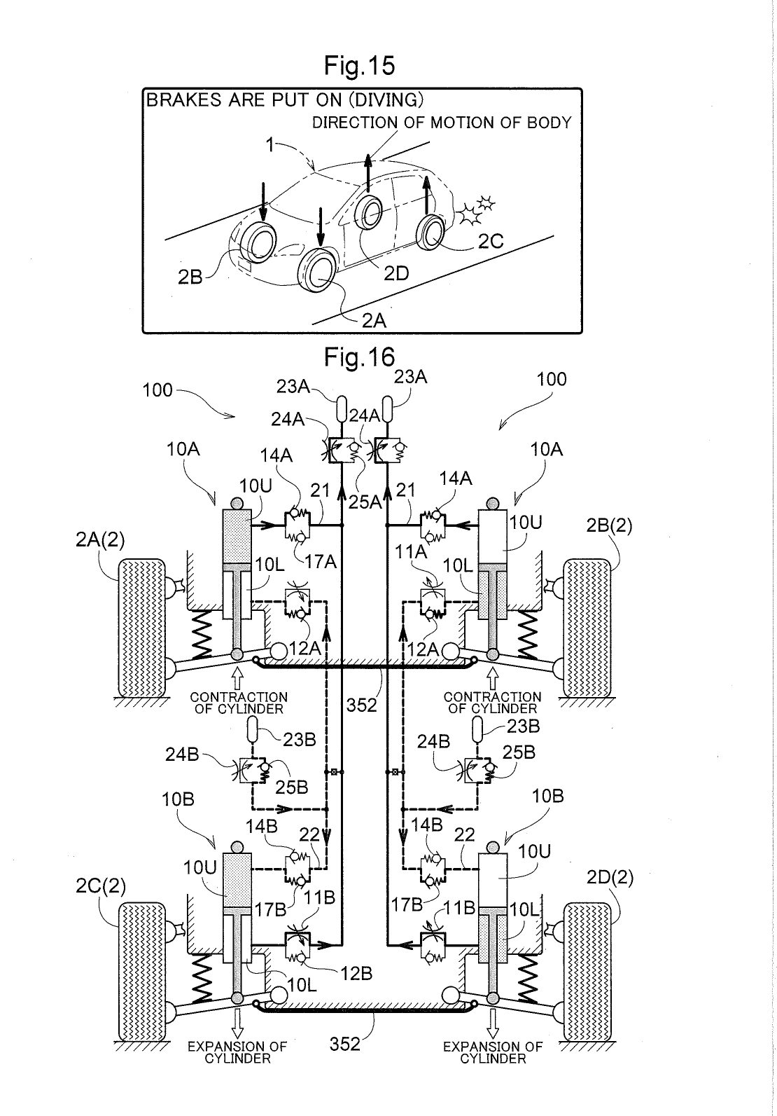

Next, an operation of the suspension system 100 of this embodiment will be described. For example, as shown in FIG. 15, when the brakes are put on in the vehicle 1, a front portion of the vehicle body moves downward (dives), and at the same time, the damping force control cylinder 10A for the front wheel relatively moves in the bound direction in. At the same time, when a rear portion of the vehicle body moves upward, the damping force control cylinder 10B for the rear wheel moves relatively in the rebound direction. In this case, as shown in FIG. 16, the oil R flows out of the upper cylinder chamber 10U of the damping force control cylinder 10A on one side through the damping force valve 14A, and at the same time, the oil R also flows out of the lower cylinder chamber 10L of the damping force control cylinder 10B on the other side through the variable valve 11B. These portions of the oil R flow into the accumulator 23A through the variable valve 24A.

Also, the oil R smoothly flows into the lower cylinder chamber 10L of the damping force control cylinder 10A on one side through the check valve 12A, and at the same time, the oil R smoothly flows into the upper cylinder chamber 10U of the damping force control cylinder 10B on the other side through the check valve 17B. These portions of the oil R correspond to the oil R that has flowed out of the accumulator 23B through the check valve 25B.

At this time, a great damping force is exerted on the damping force control cylinder 10A by the damping force valve 14A for the upper cylinder chamber 10U of the damping force control cylinder 10A and the variable valve 24A for the accumulator 23A. On the other hand, a great damping force is exerted on the damping force control cylinder 10B by the variable valve 11B for the lower cylinder chamber 10L of the damping force control cylinder 10B and the variable valve 24A for the accumulator 23A.

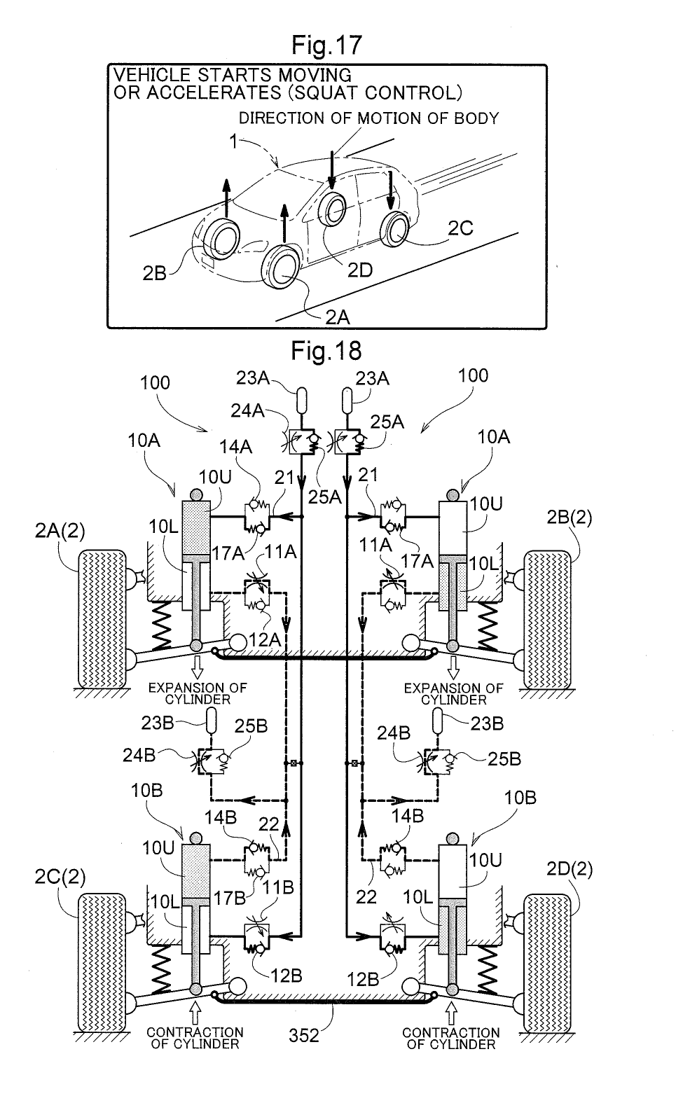

Also, for example, as shown in FIG. 17, when the vehicle 1 starts moving or accelerates, and therefore, a front portion of the vehicle 1 moves upward, the damping force control cylinder 10A for the front wheel moves relatively in the rebound direction in. At the same time, a rear portion of the vehicle moves downward (squats), and therefore, the damping force control cylinder 10B for the rear wheel moves relatively in the bound direction. In this case, as shown in FIG. 18, the oil R flows out of the lower cylinder chamber 10L of the damping force control cylinder 10A on one side through the variable valve 11A, and at the same time, the oil R also flows out of the upper cylinder chamber 10U of the damping force control cylinder 10B on the other side through the damping force valve 14B. These portions of the oil R flow into the accumulator 23B through the variable valve 24B.

Also, the oil R smoothly flows into the upper cylinder chamber 10U of the damping force control cylinder 10A on one side through the check valve 17A, and at the same time, the oil R also smoothly flows into the lower cylinder chamber 10L of the damping force control cylinder 10B on the other side through the check valve 12B. These portions of the oil R correspond to that which has flowed from the accumulator 23A through the check valve 25A.

At this time, a great damping force is exerted on the damping force control cylinder 10A by the variable valve 11A for the lower cylinder chamber 10L of the damping force control cylinder 10A and the variable valve 24B for the accumulator 23B. On the other hand, a great damping force is exerted on the damping force control cylinder 10B by the damping force valve 14B and the variable valve 24B for the accumulator 23B.

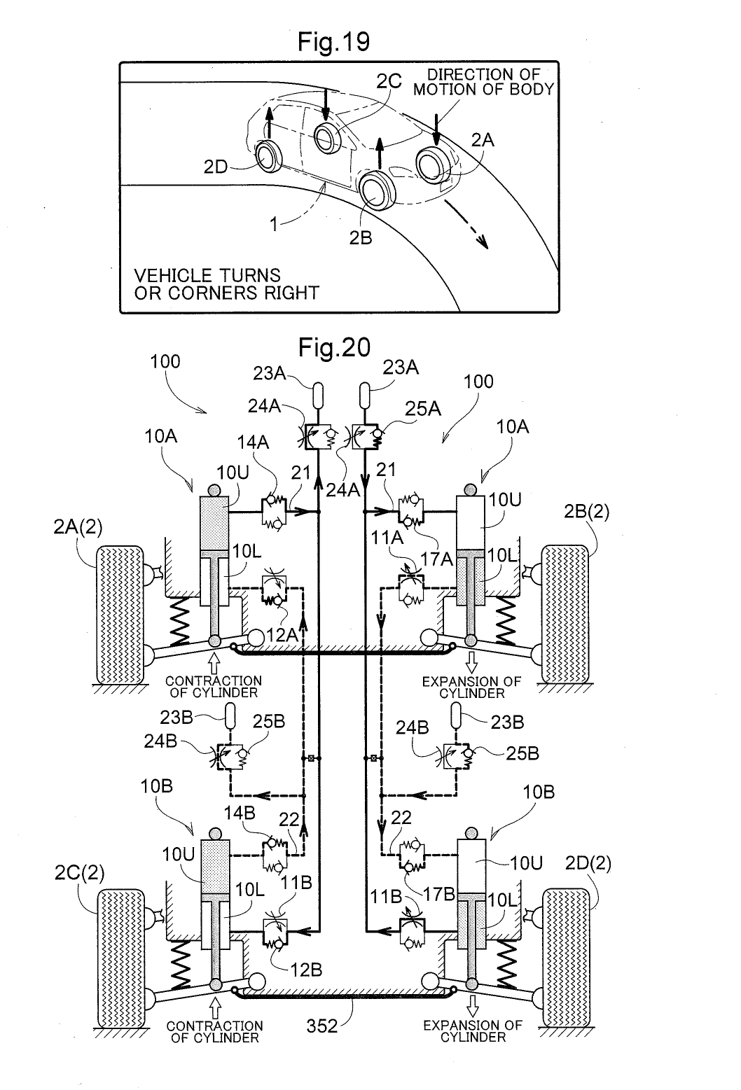

Moreover, for example, as shown in FIG. 19, when the vehicle 1 travels while turning or cornering right, an upward load is exerted on the right side of the vehicle 1, and a downward load is exerted on the left side of the vehicle 1. In this case, as shown in FIG. 20, the oil R flows from the upper cylinder chamber 10U of the damping force control cylinder 10B incorporated in the left rear wheel 2C through the damping force valve 14B. This oil R smoothly flows into the lower cylinder chamber 10L of the damping force control cylinder 10A incorporated in the left front wheel 2A through the check valve 12A, and at the same time, a small amount of the oil R corresponding to the advance of the rod of the damping force control cylinder 10A flows into the accumulator 23B through the variable valve 24B.

Also, the oil R flows out of the upper cylinder chamber 10U of the damping force control cylinder 10A incorporated in the left front wheel 2A through the damping force valve 14A. This oil R smoothly flows into the lower cylinder chamber 10L of the damping force control cylinder 10B incorporated in the left rear wheel 2C through the check valve 12B, and at the same time, a small amount of the oil R corresponding to the advance of the rod of the damping force control cylinder 10B flows into the accumulator 23A through the variable valve 24A.

At this time, a damping force is exerted on the damping force control cylinder 10B by the damping force valve 14B. However, the amount of the oil R that flows into the variable valve 24B for the accumulator 23B is small because it corresponds to the advance of the rod of the damping force control cylinder 10B, and therefore, the action of the damping force is small. On the other hand, a damping force is exerted on the damping force control cylinder 10A by the damping force valve 14A. However, the amount of the oil R that flows into the variable valve 24A for the accumulator 23A is small because it corresponds to the advance of the rod of the damping force control cylinder 10B, and therefore, the action of the damping force is small.

On the other hand, the oil R flows out of the lower cylinder chamber 10L of the damping force control cylinder 10A incorporated in the right front wheel 2B through the variable valve 11A. This oil R smoothly flows into the upper cylinder chamber 10U of the damping force control cylinder 10B incorporated in the right rear wheel 2D through the check valve 17B. Also, the oil R having an amount corresponding to the volume of the rod that is discharged from the lower cylinder chamber 10L, flows from the accumulator 23B into the upper cylinder chamber 10U through the check valve 25B. At this time, a damping force is generated by the variable valve 11A for the lower cylinder chamber 10L, in a direction in which the damping force control cylinder 10A expands.

Also, the oil R flows out of the lower cylinder chamber 10L of the damping force control cylinder 10B incorporated in the right rear wheel 2D through the variable valve 11B. This oil R smoothly flows into the upper cylinder chamber 10U of the damping force control cylinder 10A incorporated in the right front wheel 2B through the check valve 17A. Also, the oil R having an amount corresponding to the volume of the rod that is discharged from the lower cylinder chamber 10L, flows from the accumulator 23A into the upper cylinder chamber 10U through the check valve 25A and the check valve 17A. At this time, a damping force is mainly generated by the variable valve 11B for the lower cylinder chamber 10L in a direction in which the damping force control cylinder 10B expands.

As a result, the suspension system 100 functions as a suspension having a damping force control. As a result, the suspension system 100 functions as a suspension having a damping force control. A motion of the vehicle body caused by an under-spring input force (shake) from a road surface is estimated by the acceleration detector 30 provided in the vehicle 1, to optimally control a damping force in the expansion direction for each wheel, whereby the shake of the wheel 2 is reduced to improve road holding, and therefore, sufficient ride quality and driving stability are ensured. Also, when a pitch force is exerted on the vehicle 1, the longitudinal direction and the pitch speed are detected using the acceleration detector 30, and the variable valve 24 provided for the accumulator 23 in the hydraulic circuit that provides the effect of damping pitch is controlled using a controller to damp the pitch. Also, when a force is exerted in the roll direction, the oil R moves between the upper and lower cylinder chambers 10U and 10L of the damping force control cylinders 10 incorporated in the left and right front and rear wheels, and therefore, the force for damping the roll is not sufficient, and therefore, the stabilizer 352 is used to reduce the roll. Therefore, vehicle stability can be further improved.

### 1-4. Fourth Embodiment

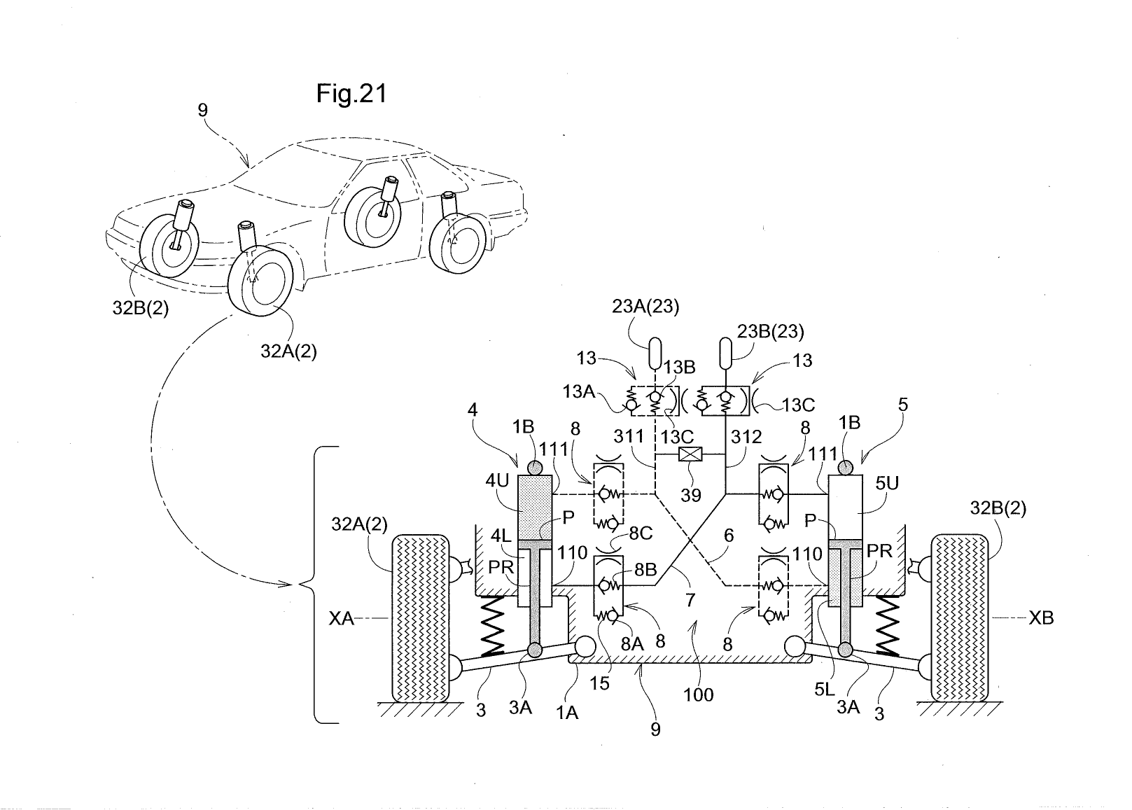

FIG. 21 is a schematic diagram showing a suspension system 100 according to a fourth embodiment, particularly a portion thereof including a pair of front wheels (or rear wheels). The suspension system 100 of this embodiment is applicable to a pair of left and right wheels 2 that is at least one of a pair of front wheels and a pair of rear wheels. A left wheel 32A and a right wheel 32B are attached to a vehicle body 9 in a manner that allows the wheels to rotate about rotation axes XA and XB, respectively. The wheels 2 are attached to the vehicle body 9 in a manner that allows the wheels 2 to move up and down by a left hydraulic cylinder 4 and a right hydraulic cylinder 5. Specifically, the wheels 2 are attached to the vehicle body 9 by respective link members 3 that extend laterally from respective end portions 1A of the vehicle body 9 and can swing up and down. Also, upper end portions of the left and right hydraulic cylinders 4 and 5 are attached to respective support members 1B of the vehicle body 9, and lower end portions thereof are attached to middle portions 3A of the respective link members 3. Thus, the left and right hydraulic cylinders 4 and 5 are configured to be expanded and contracted by relative vertical movements of the vehicle body 9 and the respective wheels 2.

The suspension system 100 of this embodiment includes: the left and right hydraulic cylinders 4 and 5 that are attached between the left and right support members 1B of the vehicle body 9 and the middle portions 3A of the left and right link members 3; a first fluid path 6 through which an upper cylinder chamber 4U of the left hydraulic cylinder 4 and a lower cylinder chamber 5L of the right hydraulic cylinder 5 are connected together in communication with each other; a second fluid path 7 through which an upper cylinder chamber 5U of the right hydraulic cylinder 5 and a lower cylinder chamber 4L of the left hydraulic cylinder 4 are connected together in communication with each other; differential pressure mechanisms 8 that are provided for ports 110 and 111 of the cylinder chambers 4U, 4L, 5U, and 5L, one for each port, and each provide a difference in input/output pressure of oil R for the corresponding port 110 or 111; and accumulators 23A and 23B that are provided in communication with the first and second fluid paths 6 and 7, respectively. Thus, there are a pair of the accumulators 23A and 23B.

Note that the accumulators 23A and 23B generates a system pressure to allow the oil R to flow in from the cylinder chambers 4U, 4L, 5U, and 5L, or conversely, to supply the oil R to the cylinder chambers 4U, 4L, 5U, and 5L. Also, the accumulators 23A and 23B are provided in order to impart roll stiffness to the vehicle. The containers of the accumulators 23A and 23B are filled with a gas. The volume of the gas varies depending on the volume of the oil R. As a result, the accumulators 23A and 23B each act as a gas spring. Specifically, when the oil R flows into the accumulator 23A, 23B, the gas is compressed, and the gas spring's force (restoring force) is exerted on the oil R, whereby roll stiffness (stabilizer function) can be imparted to the vehicle.

The first fluid path 6 and the accumulator 23A are connected together in communication with each other through a third fluid path 311. On the other hand, the second fluid path 7 and the accumulator 23B are connected together in communication with each other through a fourth fluid path 312. Load mechanisms 13 that exert a load when the oil R enters the accumulators 23A and 23B are provided in the third and fourth fluid paths 311 and 312, respectively. A communication mechanism 39 that allows the oil R to move therethrough to keep a balance against the vehicle's tilt etc. that is caused by a difference in the volume of oil between the third and fourth fluid paths 311 and 312 due to an increase or decrease in the oil volume, is provided between the third and fourth fluid paths 311 and 312.

The hydraulic cylinders 4 and 5 are each divided into an upper and a lower cylinder chamber by a piston P. Piston rods PR are provided, penetrating through the lower cylinder chambers 4L and 5L, respectively.

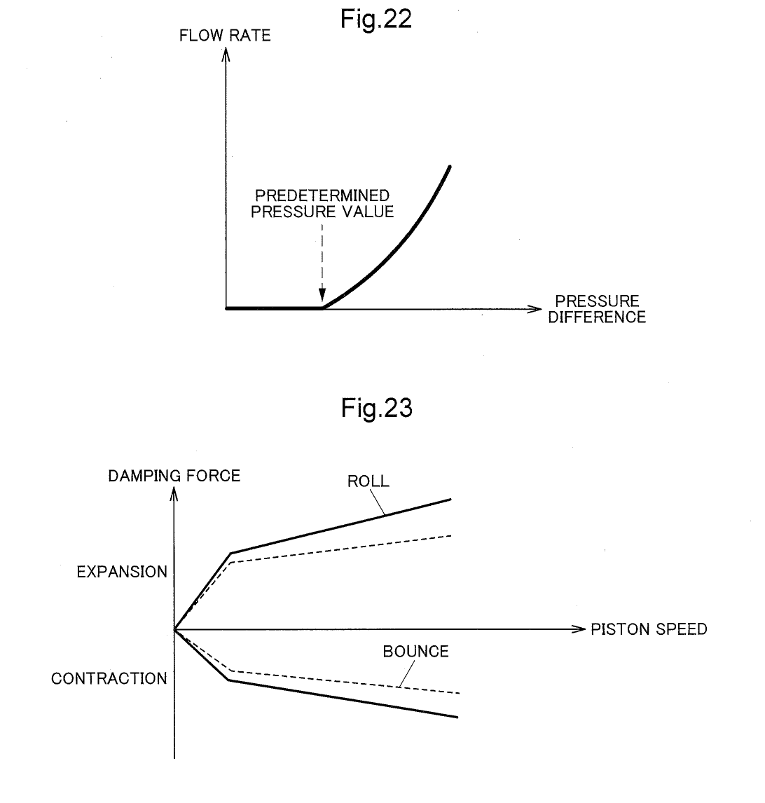

The differential pressure mechanism 8 includes: a check valve 8A that allows the oil R to only enter the cylinder chamber; a damping force valve 8B that allows the oil R to be only discharged from the cylinder chamber, and adjusts the flow rate of the oil R based on the pressure difference, where the damping force valve 8B is opened when the pressure difference is larger than or equal to a predetermined pressure value; and an orifice 8C that imparts a resistance when the oil R is discharged. A relationship between pressure differences of the damping force valve 8B and flow rates is shown in FIG. 22.

The check valve 8A and the damping force valve 8B each include a spring 15 that exerts a closing force on the disc. The check valve 8A and the damping force valve 8B may be configured so that as the closing force of the spring 15 increases, the flow resistance of the oil R also increases, and conversely, as the closing force decreases, the flow resistance of the oil R decreases. The check valve 8A and the damping force valve 8B may have a leaf valve structure. Note that the check valve 8A does not have a high flow resistance, in order to allow the oil R to easily flow in. The degree of opening of the damping force valve 8B varies depending on the flow rate and the pressure difference, and the damping force valve 8B generates a damping force corresponding to the opening degree. To achieve this, for example, the damping force valve 8B is configured so that a flat spring etc. is used to exert an elastic force in a direction in which the flow passage is closed.

In this embodiment, in the differential pressure mechanism 8, the flow resistance of the oil R as it is discharged from the cylinder chambers 4U, 4L, 5U, and 5L is set to be higher than the flow resistance of the oil R as it enters the cylinder chamber 4U, 4L, 5U, and 5L. Specifically, a damping force that is generated when the oil R is discharged from the cylinder chambers 4U, 4L, 5U, and 5L through the damping force valve 8B is set to be greater than a damping force that is generated when the oil R enters the cylinder chambers 4U, 4L, 5U, and 5L through the check valve 8A.

Also, the damping force valve 8B and the orifice 8C are configured to provide a relationship between piston speeds and flow resistances (corresponding to damping forces) that is shown in FIG. 23. As shown in FIG. 23, when the piston speed is low, the flow resistance caused by the orifice 8C is dominating. When the piston speed is high, then after the damping force valve 8B is opened, the flow resistance of the damping force valve 8B is added. As can be seen from FIG. 23, desired damping suitable for the piston speed can be obtained.

As shown in FIG. 21, the load mechanism 13 includes a damping force valve 13A (corresponding to a “second accumulator valve” according to the present invention), a check valve 13B (corresponding to a “first accumulator valve” according to the present invention), and an orifice 13C. The check valve 13B is provided for each of the accumulators 23A and 23B in order to discharge the oil R from each of the accumulators 23A and 23B. Therefore, the check valve 13B allows for only the discharge of the oil R from the accumulator 23A, 23B. The damping force valve 13A is provided for each of the accumulators 23A and 10 in order to adjust the flow rate of the oil R entering each of the accumulators 23A and 23B. Therefore, the damping force valve 13A allows the oil R to only enter the accumulator 23A, 23B, and adjusts the flow rate based on the value of the pressure, where the damping force valve 13A is opened when the pressure is higher than or equal to a predetermined pressure value.

The damping force valve 13A and the check valve 13B each include a spring that exerts a closing force on the disc. The damping force valve 13A and the check valve 13B may be configured so that as the closing force of the spring increases, the flow resistance of the oil R also increases, and conversely, as the closing force decreases, the flow resistance of the oil R decreases. The damping force valve 13A and the check valve 13B may have a leaf valve structure. Also, the damping force valve 13A is configured to exert on the oil R a load that is greater than that which the check valve 13B exerts on the oil R. Specifically, the check valve 13B has a low flow resistance so that the oil R smoothly flows out of the accumulator 23A, 23B, and the damping force valve 13A is configured to generate a suitable damping force.

Here, the present invention is not limited to the configuration that the damping force valve 13A for the accumulator 23A exerts on the oil R a load that is greater than that which the check valve 13B for the accumulator 23A exerts on the oil R, and the damping force valve 13A for the accumulator 23B exerts on the oil R a load that is greater than that which the check valve 13B for the accumulator 23B exerts on the oil R. Alternatively, the damping force valve 13A provided for the accumulator 23A may exert on the oil R a load that is greater than that which the check valve 13B exerts on the oil R, the check valve 13B being provided for the accumulator 23B that is located on a side different from that on which the accumulator 23A for which the damping force valve 13A is provided is located. Also, the damping force valve 13A provided for the accumulator 23B may exert on the oil R a load that is greater than that which the check valve 13B exerts on the oil R, the check valve 13B being provided for the accumulator 23A that is located on a side different from that on which the accumulator 23A for which the damping force valve 13A is provided is located.

Moreover, of course, the damping force valve 13A provided for the accumulator 23A may exert on the oil R a load that is greater than that which the check valve 13B provided for the accumulator 23A exerts on the oil R, and the damping force valve 13A provided for the accumulator 23B may exert on the oil R a load that is greater than that which the check valve 13B provided for the accumulator 23B exerts on the oil R, and the damping force valve 13A provided for the accumulator 23A may exert on the oil R a load that is greater than that which the check valve 13B provided for the accumulator 23B exerts on the oil R, and the damping force valve 13A provided for the accumulator 23B may exert on the oil R a load that is greater than that which the check valve 13B provided for the accumulator 23A exerts on the oil R.

Also, as with the orifice 8C, the orifice 13C can adjust the damping force when the piston speed is within a low region. Note that the orifice 13C is not necessarily needed, and may be removed, depending on the performance that the suspension system 100 is required to have.

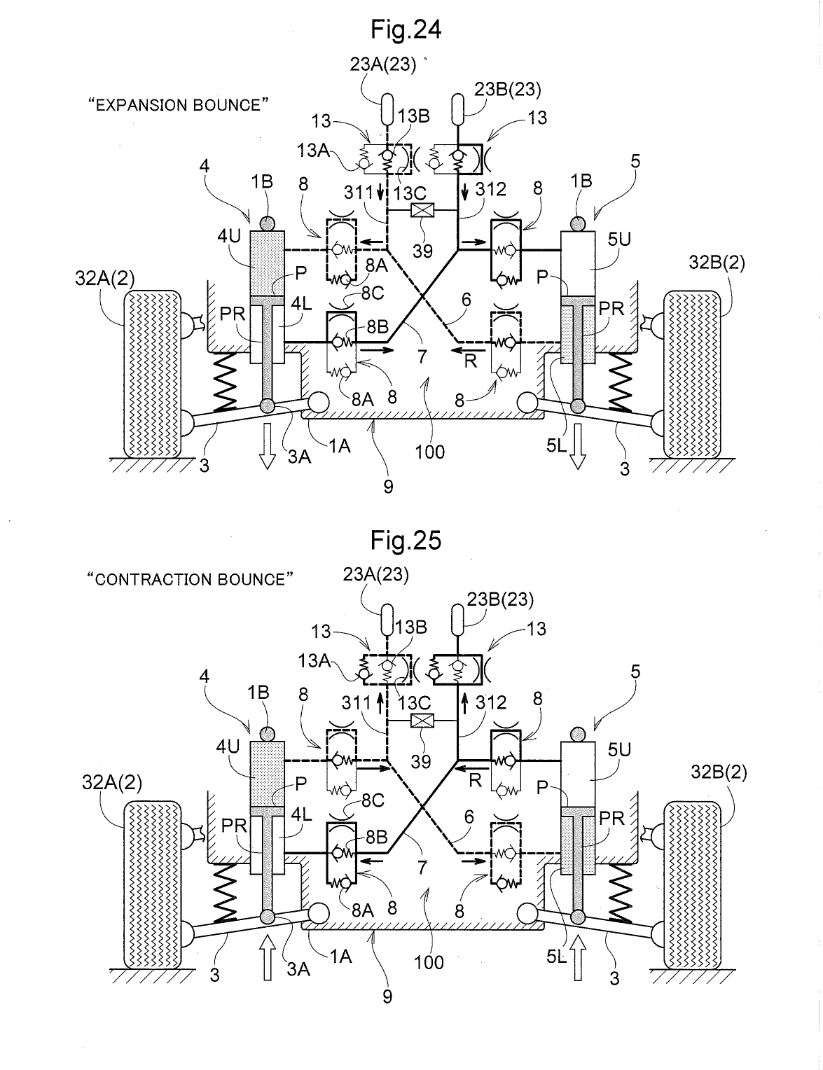

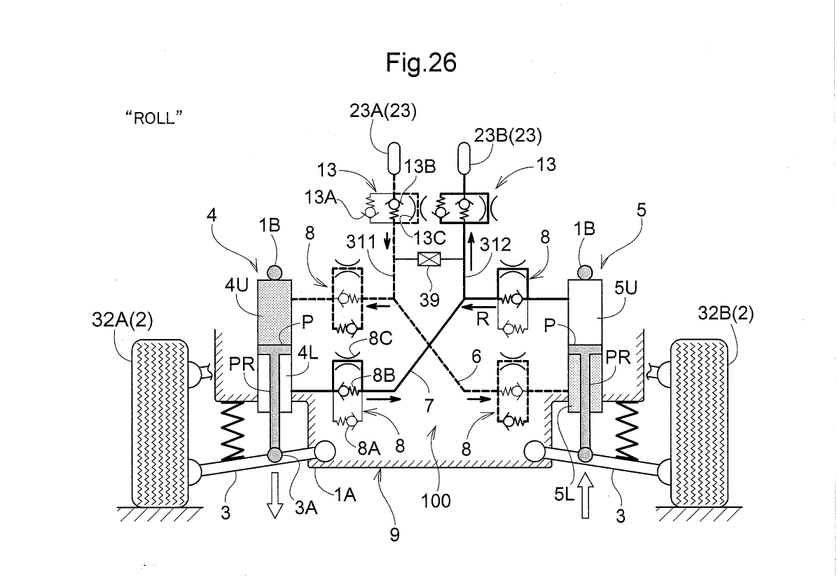

Next, operations of the suspension system 100 with respect to motions of the wheels 2 will be described. The following motions of the wheels 2 will be described: “expansion bounce” that the left and right hydraulic cylinders 4 and 5 expand together as shown in FIG. 24; “contraction bounce” that the left and right hydraulic cylinders 4 and 5 contract together as shown in FIG. 25; and “roll” that one of the left and right hydraulic cylinders 4 and 5 expands while the other one contracts as shown in FIG. 26.

The “expansion bounce” occurs when both of the wheels 2 rebound. As shown in FIG. 24, during the “expansion bounce,” the oil R is discharged from both of the lower cylinder chambers 4L and 5L, and flows through the corresponding differential pressure mechanism 8 into the upper cylinder chambers 5U and 4U of the respective opposite cylinders. At this time, the absolute value of the amount of expansion or contraction is the same between the lower cylinder chamber 4L (5L) on one side and the upper cylinder chamber 5U (4U) on the other side, and therefore, the oil R having an amount corresponding to the volume of the piston rod PR that is discharged from the lower cylinder chamber 4L (5L), smoothly flows from the accumulator 23B (23A) through the check valve 13B to the upper cylinder chamber 5U (4U).

During the above flow of the oil R, the oil R is mainly discharged through the differential pressure mechanisms 8 corresponding to the lower cylinder chambers 4L and 5L, to generate damping forces. Also, at this time, in the differential pressure mechanisms 8 corresponding to the upper cylinder chambers 4U and 5U, the check valve 8A is set to have characteristics that allow the oil R to smoothly flow into the upper cylinder chambers 4U and 5U in order to ensure a sufficient liquid pressure in the cylinder chambers.

The “contraction bounce” occurs when both of the wheels 2 bound. As shown in FIG. 25, during the “contraction bounce,” the oil R is discharged from both of the upper cylinder chambers 4U and 5U, and flows through the corresponding differential pressure mechanisms 8 into the lower cylinder chambers 5L and 4L of the respective opposite cylinders. At this time, the absolute value of the amount of expansion or contraction is the same between the upper cylinder chamber 4U (5U) on one side and the lower cylinder chamber 5L (4L) on the other side, and therefore, the oil R having an amount corresponding to the volume of the piston rod PR that enters the upper cylinder chamber 4U (5U), flows through the load mechanism 13 into the accumulator 23A (23B).

During the above flow of the oil R, the oil R is discharged through the differential pressure mechanisms 8 corresponding to the upper cylinder chambers 4U and 5U, to generate damping forces. Note that, at this time, the flow rate of the oil R having an amount corresponding to the volume of the rod that passes through the load mechanism 13, is low, and the damping force generated by the load mechanism 13 is small. Also, in the differential pressure mechanisms 8 corresponding to the lower cylinder chambers 4L and 5L, the check valve 8A is set to have characteristics that allow the oil R to smoothly enter the lower cylinder chambers 4L and 5L in order to ensure a sufficient liquid pressure in the cylinder chambers.

The “roll” occurs when the vehicle turns or corners right or left. Here, a case where the vehicle turns or corners left will be described. The left wheel 32A (an inner wheel during turning or cornering) relatively moves in the rebound direction, and as shown in FIG. 26, the oil R is discharged from the lower cylinder chamber 4L, and flows through the corresponding differential pressure mechanism 8 and load mechanism 13 into the accumulator 23B. The right wheel 32B (an outer wheel during turning or cornering) relatively moves in the bound direction, and as shown in FIG. 26, the oil R is discharged from the upper cylinder chamber 5U, and flows through the corresponding differential pressure mechanism 8 and load mechanism 13 into the accumulator 23B. At this time, a significant damping effect can be achieved by the differential pressure mechanism 8 corresponding to the lower cylinder chamber 4L of the left hydraulic cylinder 4, the differential pressure mechanism 8 corresponding to the upper cylinder chamber 5U of the right hydraulic cylinder 5, and the load mechanism 13 corresponding to the accumulator 23B.

Also, the oil R is supplied from the accumulator 23A to the upper cylinder chamber 4U of the left hydraulic cylinder 4 and the lower cylinder chamber 5L of the right hydraulic cylinder 5. In the differential pressure mechanisms 8 corresponding to the upper and lower cylinder chambers 4U and 5L, the check valves 8A for the upper and lower cylinder chambers 4U and 5L are set so that the oil R smoothly enter the upper and lower cylinder chambers 4U and 5L in order to ensure sufficient liquid pressures of the lower and upper cylinder chambers 4L and 5U.

The characteristics of a shock damping force with respect to the above-described “expansion bounce,” “contraction bounce,” and “roll” may be shown in FIG. 23 described above. Dashed lines indicate “expansion bounce” and “contraction bounce,” and solid lines indicate “roll.” The horizontal axis represents piston speeds, and the vertical axis represents damping forces. As the piston speed changes, the lines bend. In an initial area where the lines have a steep slope, the damping effect of the orifice 8C of the differential pressure mechanism 8 is provided. In an area where the lines have a gentle slope, the damping effect of each of the differential pressure mechanism 8 and the load mechanism 13 is provided.

In the suspension system 100 of this embodiment, “bounce” and “roll” can be satisfactorily damped by the action of the differential pressure mechanism 8 and the load mechanism 13 depending on the vertical motion of the wheels 2, to simultaneously ensure sufficient driving stability and good ride quality, without using a complicated mechanical mechanism or control mechanism. Also, the suspension system 100 of this embodiment can have both the absorber function and the stabilizer function, and therefore, a stabilizer bar can be removed, resulting in a simpler structure around the wheels 2.

### 1-5. Fifth Embodiment

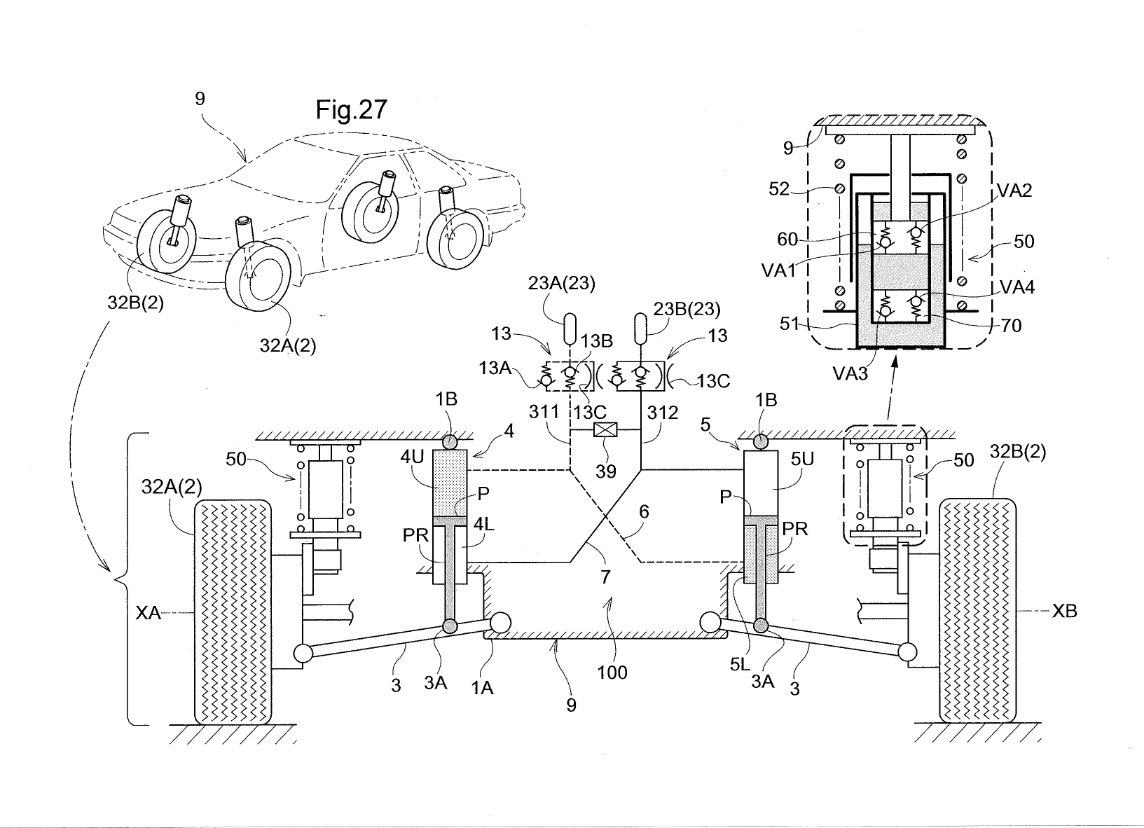

Next, a fifth embodiment of the present invention will be described. FIG. 27 shows a vehicle body 9 including a suspension system 100 according to this embodiment. The suspension system 100 of the fifth embodiment is different from that of the fourth embodiment in that, although the suspension system 100 of the fourth embodiment includes the differential pressure mechanism 8, a suspension mechanism 50 is provided instead of the differential pressure mechanism 8. Differences will now be mainly described.

Also in the suspension system 100 of this embodiment, a left hydraulic cylinder 4 and a right hydraulic cylinder 5 are attached, extending from a left and a right support member 1B of the vehicle body 9 to middle portions 3A of a left and a right link member 3, respectively. Therefore, the left and right hydraulic cylinders 4 and 5 are provided between a position where the support member 1B of the vehicle body 9 is connected and the suspension mechanism 50 as viewed in the horizontal direction. Also, an upper cylinder chamber 4U of the left hydraulic cylinder 4 and a lower cylinder chamber 5L of the right hydraulic cylinder 5 are connected together in communication with each other through a first fluid path 6. An upper cylinder chamber 5U of the right hydraulic cylinder 5 and a lower cylinder chamber 4L of the left hydraulic cylinder 4 are connected together in communication with each other through a second fluid path 7. Accumulators 23A and 23B are provided in communication with the first and second fluid paths 6 and 7, respectively.

The first fluid path 6 and the accumulator 23A are connected together in communication with each other through a third fluid path 311. The second fluid path 7 and the accumulator 23B are connected together in communication with each other through a fourth fluid path 312. A load mechanism 13 is provided for each of the third and fourth fluid paths 311 and 312. Also, a communication mechanism 39 is provided between the third and fourth fluid paths 311 and 312.

Also in this embodiment, the load mechanism 13 includes a damping force valve 13A, a check valve 13B, and an orifice 13C. The damping force valve 13A is configured to exert on oil R a load that is greater than that which the check valve 13B exerts on the oil R. As a result, the load mechanism 13 has the stabilizer function of reducing the roll of the vehicle body 9.

Here, in this embodiment described above, the differential pressure mechanism 8 for damping the bounce of the vehicle body 9 is not provided. Therefore, in the suspension system 100 of this embodiment, the suspension mechanism 50 is provided in order to enhance the absorber function. The suspension mechanism 50 is provided for each of the left and right hydraulic cylinders 4 and 5, and is arranged in parallel with the corresponding left or right hydraulic cylinder 4 or 5, with the wheel 2 hanging from the suspension mechanism 50. The suspension mechanism 50 includes a so-called “shock absorber” that includes a hydraulic damper 51 and a spring 52. A known shock absorber may be employed, and therefore, the configuration of the shock absorber will not be described. In this embodiment, the hydraulic damper 51, which is of the twin-tube type, includes a piston valve 60 that includes a check valve VA1 and a damping force valve VA2, and a base valve 70 that includes a check valve VA3 and a damping force valve VA4. A damping force caused by the damping force valve VA4 is set to be greater than a damping force caused by the damping force valve VA2. Damping forces caused by the check valves VA1 and VA3 are set to be considerably smaller than the damping force caused by the damping force valve VA2.

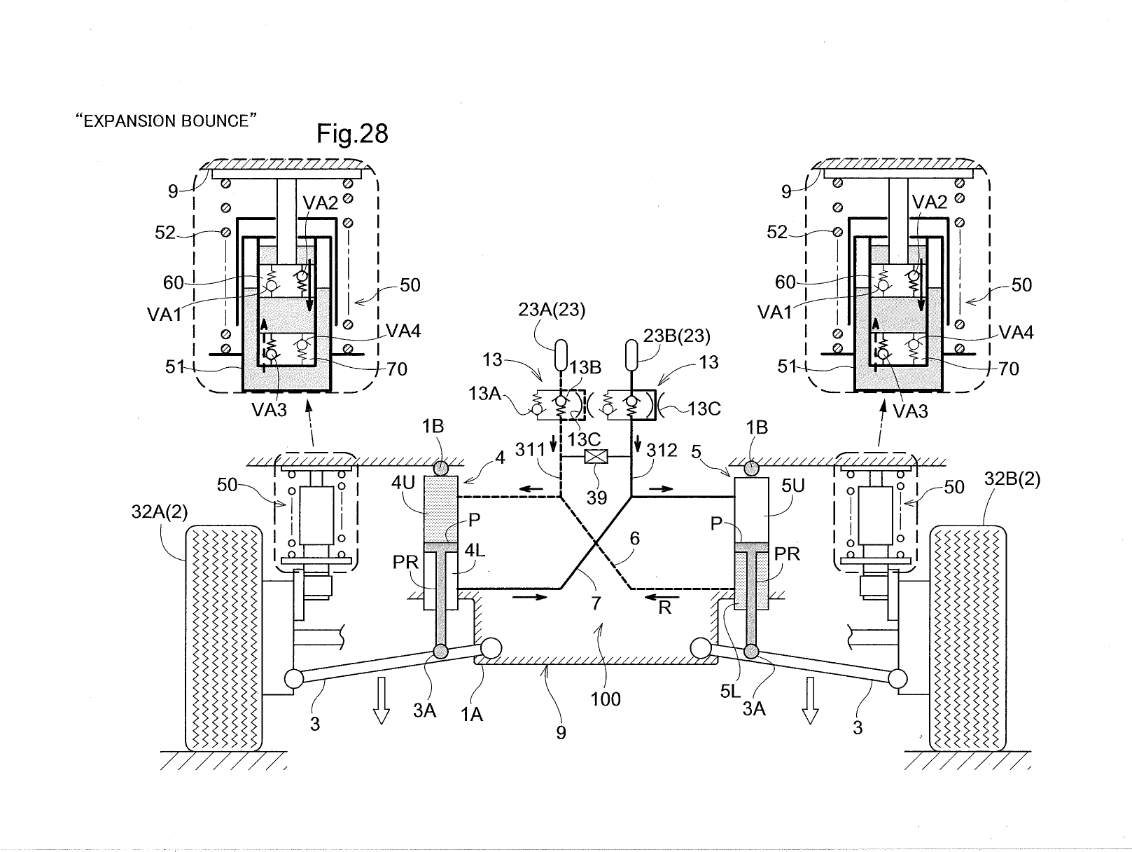

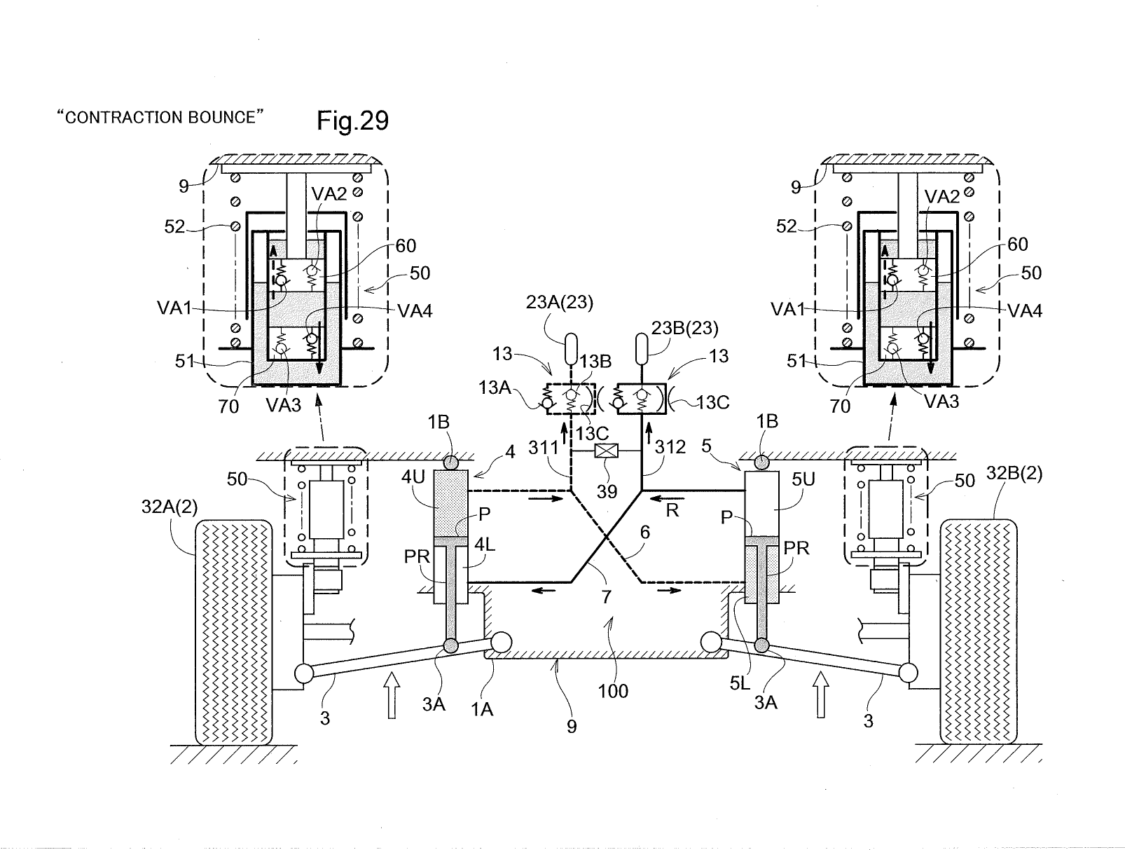

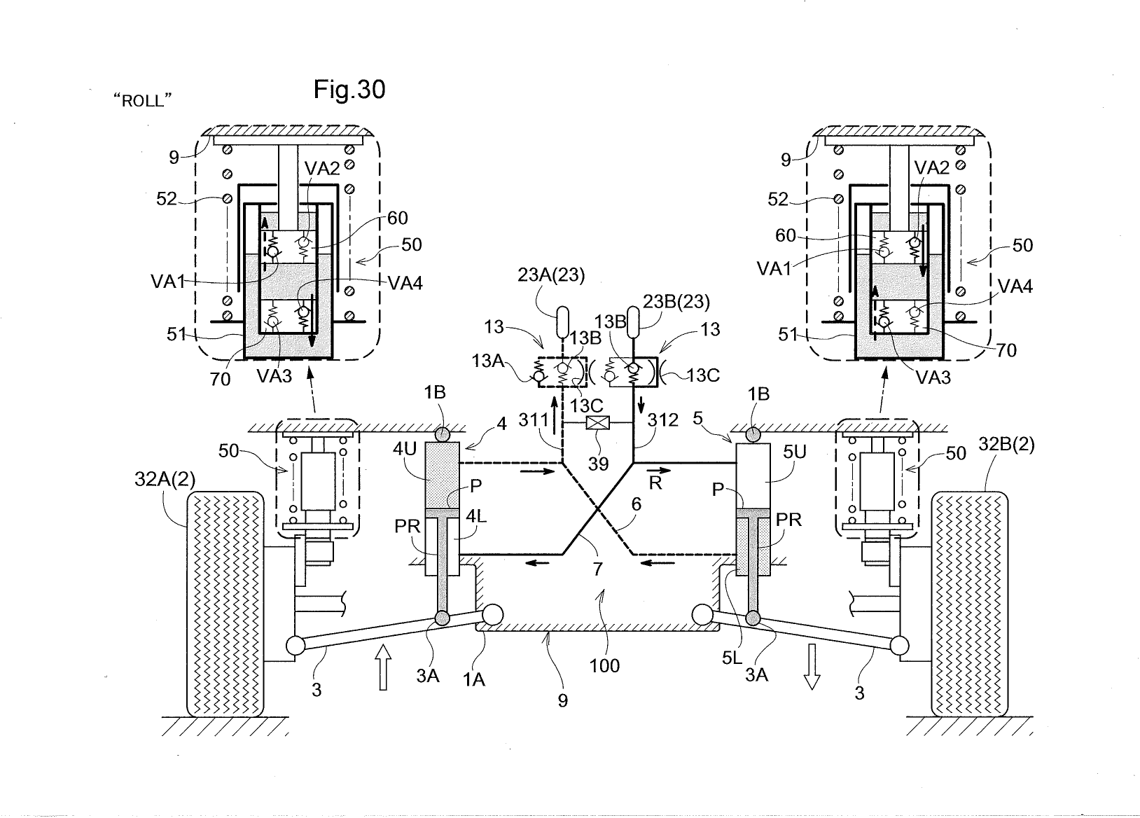

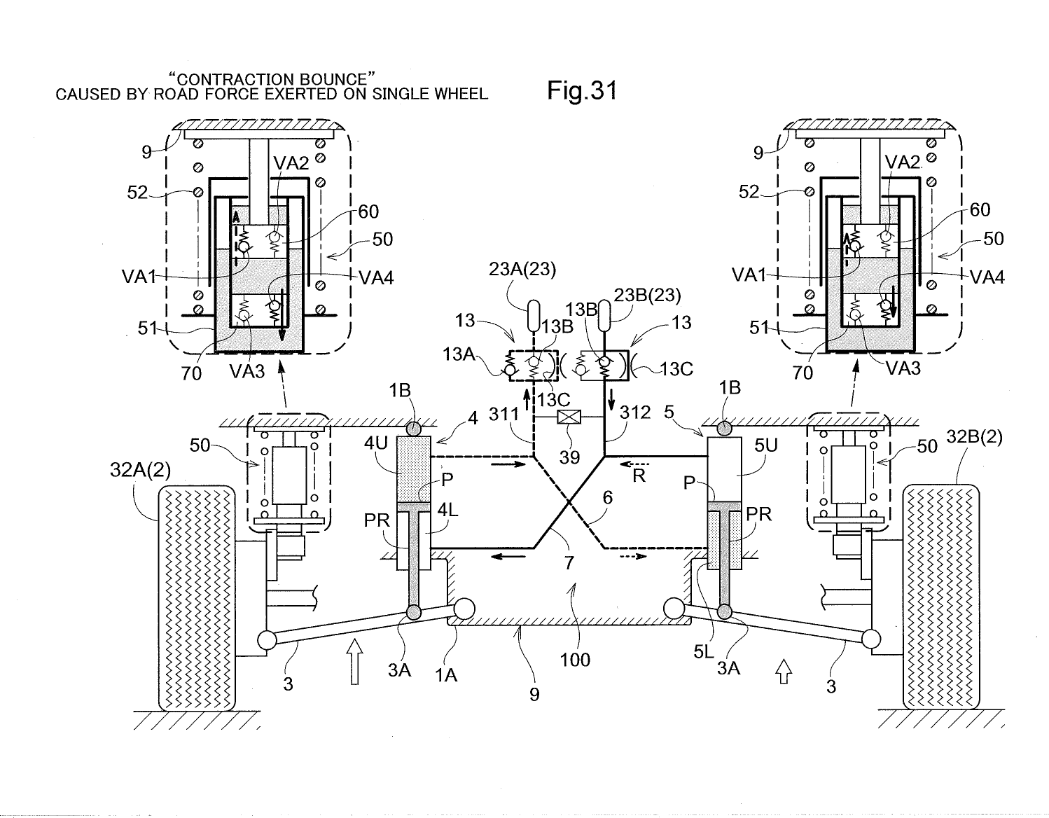

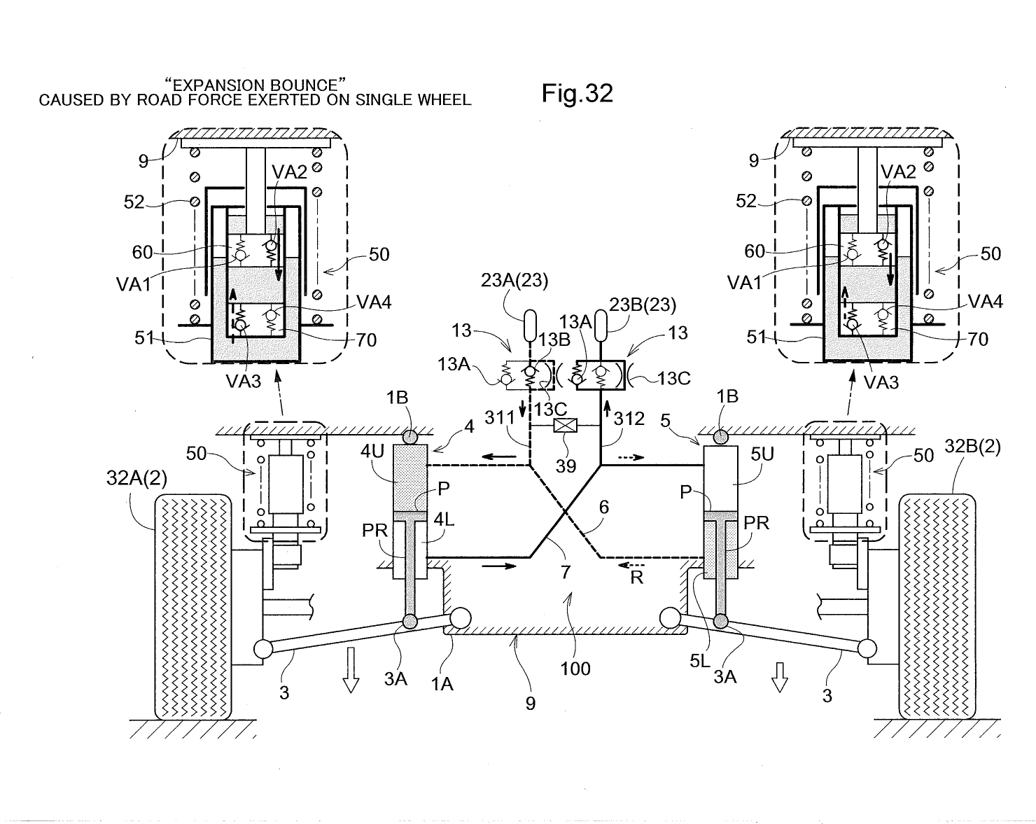

Next, operations of the suspension system 100 with respect to motions of the wheels 2 will be described. The following motions of the wheels 2 will be described: “expansion bounce” that the left and right hydraulic cylinders 4 and 5 expand together as shown in FIG. 28; “contraction bounce” that the left and right hydraulic cylinders 4 and 5 contract together as shown in FIG. 29; “roll” that one of the left and right hydraulic cylinders 4 and 5 expands while the other one contracts as shown in FIG. 30; “contraction bounce” that is caused by a road force exerted on a single wheel as shown in FIG. 31; and “expansion bounce” that is caused by a road force exerted on a single wheel as shown in FIG. 32.

The “expansion bounce” occurs when both of the wheels 2 rebound. As shown in FIG. 28, during the “expansion bounce,” the oil R is discharged from both of the lower cylinder chambers 4L and 5L, and flows into the upper cylinder chambers 5U and 4U of the respective opposite cylinders. At this time, the absolute value of the amount of expansion or contraction is the same between the lower cylinder chamber 4L (5L) on one side and the upper cylinder chamber 5U (4U) on the other side, and therefore, the oil R having an amount corresponding to the volume of the piston rod PR that is discharged from the lower cylinder chamber 4L (5L), smoothly flows from the accumulator 23B (23A) through the check valve 13B to the upper cylinder chamber 5U (4U). Also, at this time, the left and right hydraulic dampers 51 of the suspension mechanism 50 also try to expand together. Therefore, the damping force valve VA2 generates a damping force.

As described above, in “expansion bounce,” substantially no damping force is generated by the left and right hydraulic cylinders 4 and 5, and only the hydraulic dampers 51 of the suspension mechanism 50 generate a damping force. By thus generating a suitable damping force by expansion to ensure sufficient road holding of the vehicle, sufficient driving stability and good ride quality can be simultaneously ensured.

The “contraction bounce” occurs when both of the wheels 2 bound. As shown in FIG. 29, during the “contraction bounce,” the oil R is discharged from both of the upper cylinder chambers 4U and 5U, and flows into the lower cylinder chambers 5L and 4L of the respective opposite cylinders. At this time, the absolute value of the amount of expansion or contraction is the same between the upper cylinder chamber 4U (5U) and the lower cylinder chamber 5L (4L), and therefore, the oil R having an amount corresponding to the volume of the piston rod PR that enters the upper cylinder chamber 4U (5U), flows through the load mechanism 13 into the accumulator 23A (23B). Note that, at this time, the flow rate of the oil R having an amount corresponding to the volume of the rod that passes through the load mechanism 13, is small, and therefore, the damping force generated by the load mechanism 13 is small. Also, at this time, the left and right hydraulic dampers 51 of the suspension mechanism 50 try to contract together. Therefore, the damping force valve VA4 generates a damping force.

As described above, in “contraction bounce,” substantially no damping force is generated by the left and right hydraulic cylinders 4 and 5, and only the hydraulic dampers 51 of the suspension mechanism 50 generate a damping force. By thus generating a suitable damping force by contraction to ensure sufficient road holding of the vehicle, sufficient driving stability and good ride quality can be simultaneously ensured.

The “roll” occurs when the vehicle turns or corners right or left. Here, a case where the vehicle turns or corners right will be described. The left wheel 32A (an outer wheel during turning or cornering) relatively moves in the bound direction, and as shown in FIG. 30, the oil R is discharged from the upper cylinder chamber 4U, and flows through the load mechanism 13 into the accumulator 23A. The right wheel 32B (an inner wheel during turning or cornering) relatively moves in the rebound direction, and as shown in FIG. 30, the oil R is discharged from the lower cylinder chamber 5L, and flows through the load mechanism 13 into the accumulator 23A. At this time, a significant damping effect can be achieved by the damping force valve 13A of the load mechanism 13.

Also, the oil R is smoothly supplied from the accumulator 23B to the lower cylinder chamber 4L of the left hydraulic cylinder 4 and the upper cylinder chamber 5U of the right hydraulic cylinder 5.

Also, at this time, the hydraulic damper 51 for the left wheel 32A moves in the contraction direction, and the hydraulic damper 51 for the right wheel 32B moves in the expansion direction. Therefore, a damping force is generated by the damping force valve VA4 in the hydraulic damper 51 for the left wheel 32A, and a damping force is generated by the damping force valve VA2 in the hydraulic damper 51 for the right wheel 32B.

As described above, in “roll,” the damping forces caused by the hydraulic dampers 51 of the suspension mechanism 50 are added to the damping forces caused by the left and right hydraulic cylinders 4 and 5. By thus increasing the roll damping force to reduce roll and thereby ensure sufficient road holding of the vehicle, sufficient driving stability and good ride quality can be simultaneously ensured.

The “contraction bounce” caused by a road force exerted on a single wheel occurs when one of the left and right wheel 2 bounds as it goes over a bump etc. Here, a case where the left wheel 32A goes over a bump will be described. The left wheel 32A moves in the bound direction. In this case, as shown in FIG. 31, the right wheel 32B does not substantially move in the bound or rebound direction (substantially no stroke occurs). Because the lower cylinder chamber 5L of the right hydraulic cylinder 5 requires a pressure enough to contract the coil, the oil R discharged from the upper cylinder chamber 4U of the left hydraulic cylinder 4 does not substantially flow, and flows through the load mechanism 13 into the accumulator 23A. At this time, the damping force valve 13A of the load mechanism 13 generates a damping force corresponding to the amount and speed of the stroke.

Also, the oil R is smoothly supplied from the accumulator 23B to the lower cylinder chamber 4L of the left hydraulic cylinder 4. Note that, in this example, there is substantially no flow of the oil R into the lower cylinder chamber 5L and substantially no flow of the oil R out of the upper cylinder chamber 5U, and therefore, for ease of understanding, the flows of these portions of the oil R are indicated by dashed lines in FIG. 31.

Also, at this time, while the hydraulic damper 51 for the left wheel 32A moves in the contraction direction, the hydraulic damper 51 for the right wheel 32B does not substantially move. Therefore, in the hydraulic damper 51 for the left wheel 32A, a damping force corresponding to the amount and speed of the stroke is generated by the damping force valve VA4.

As described above, in “contraction bounce” caused by a road force exerted on a single wheel, the damping force valve 13A of the load mechanism 13 for the accumulator 23A generates a damping force, and the damping force valve VA4 for the hydraulic damper 51 for the left wheel 32A generates a damping force. By thus generating damping forces to ensure sufficient road holding of the vehicle, sufficient driving stability and good ride quality can be simultaneously ensured.

The “expansion bounce” caused by a road force exerted on a single wheel occurs when one of the left and right wheels 2 rebounds as it passes a depression etc. Here, a case where the left wheel 32A passes a depression etc. will be described. The left wheel 32A moves in the rebound direction. In this case, as shown in FIG. 32, the right wheel 32B does not substantially move in the bound or rebound direction (substantially no stroke occurs). Because the upper cylinder chamber 5U of the right hydraulic cylinder 5 requires a pressure enough to lift the vehicle body 9 up, the oil R discharged from the lower cylinder chamber 4L of the left hydraulic cylinder 4 does not substantially flow, and flows through the load mechanism 13 into the accumulator 23B. In this case, the damping force valve 13A of the load mechanism 13 generates a damping force corresponding to the amount and speed of the stroke.

Also, the oil R is smoothly supplied from the accumulator 23A to the upper cylinder chamber 4U of the left hydraulic cylinder 4. Note that, in this example, there is substantially no flow of the oil R out of the lower cylinder chamber 5L and there is substantially no flow of the oil R into the upper cylinder chamber 5U, and therefore, for ease of understanding, the flows of these portions of the oil R are indicated by dashed lines in FIG. 32.

Also, at this time, while the hydraulic damper 51 for the left wheel 32A moves in the expansion direction, the hydraulic damper 51 for the right wheel 32B does not substantially move. Therefore, in the hydraulic damper 51 for the left wheel 32A, the damping force valve VA2 generates a damping force corresponding to the amount and speed of the stroke.

As described above, in “expansion bounce” caused by a road force exerted on a single wheel, the damping force valve 13A of the load mechanism 13 for the accumulator 23B generates a damping force, and the damping force valve VA2 for the hydraulic damper 51 for the left wheel 32A generates a damping force. By thus generating damping forces to ensure sufficient road holding of the vehicle, sufficient driving stability and good ride quality can be simultaneously ensured.

### 1-6. Sixth Embodiment

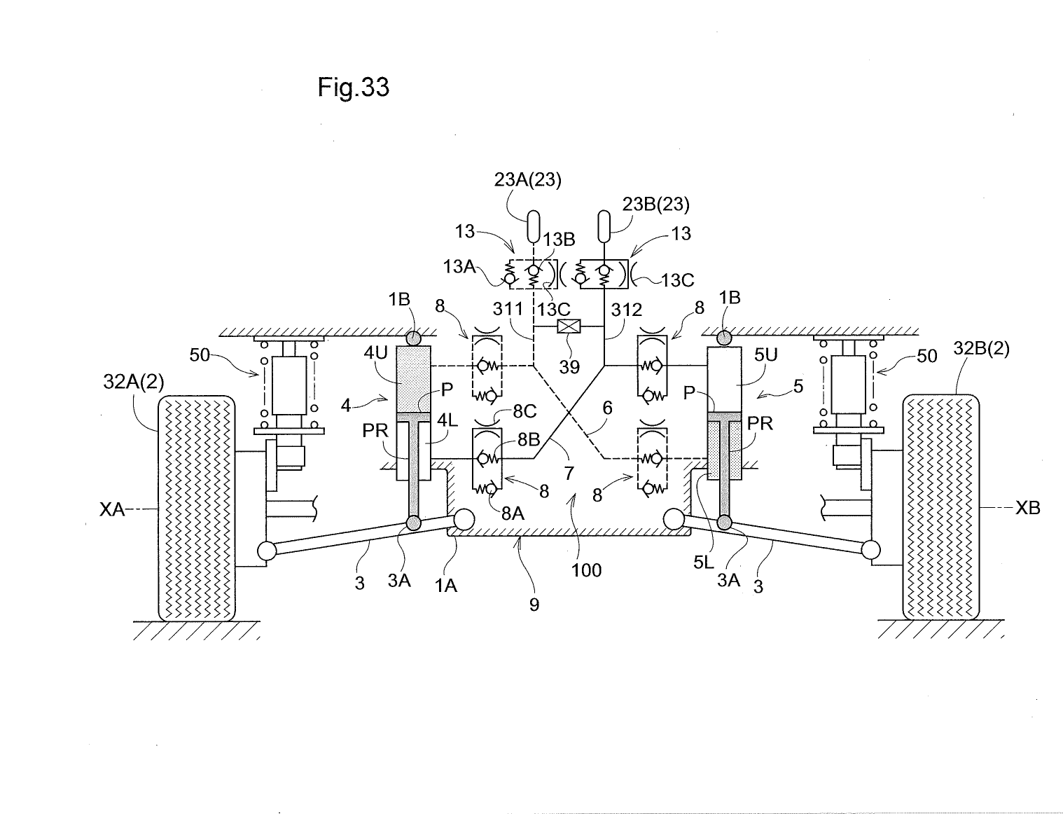

Next, a sixth embodiment according to the present invention will be described. FIG. 33 shows a vehicle body 9 including a suspension system 100 of this embodiment. The suspension system 100 of the above-described fourth embodiment includes the differential pressure mechanism 8. Also, the suspension system 100 of the above-described fifth embodiment includes the suspension mechanism 50 instead of the differential pressure mechanism 8. The sixth embodiment is different from the fourth and fifth embodiments in that the suspension system 100 of the sixth embodiment includes both the differential pressure mechanism 8 and the suspension mechanism 50. This configuration is similar to those of the fourth and fifth embodiments and will not be described.

This configuration can generate a suitable damping force, depending on the state of the vehicle, as in the fourth and fifth embodiments. Therefore, sufficient road holding of the vehicle is ensured, whereby sufficient driving stability and good ride quality can be simultaneously ensured.

### 2. Hydraulic Cylinder

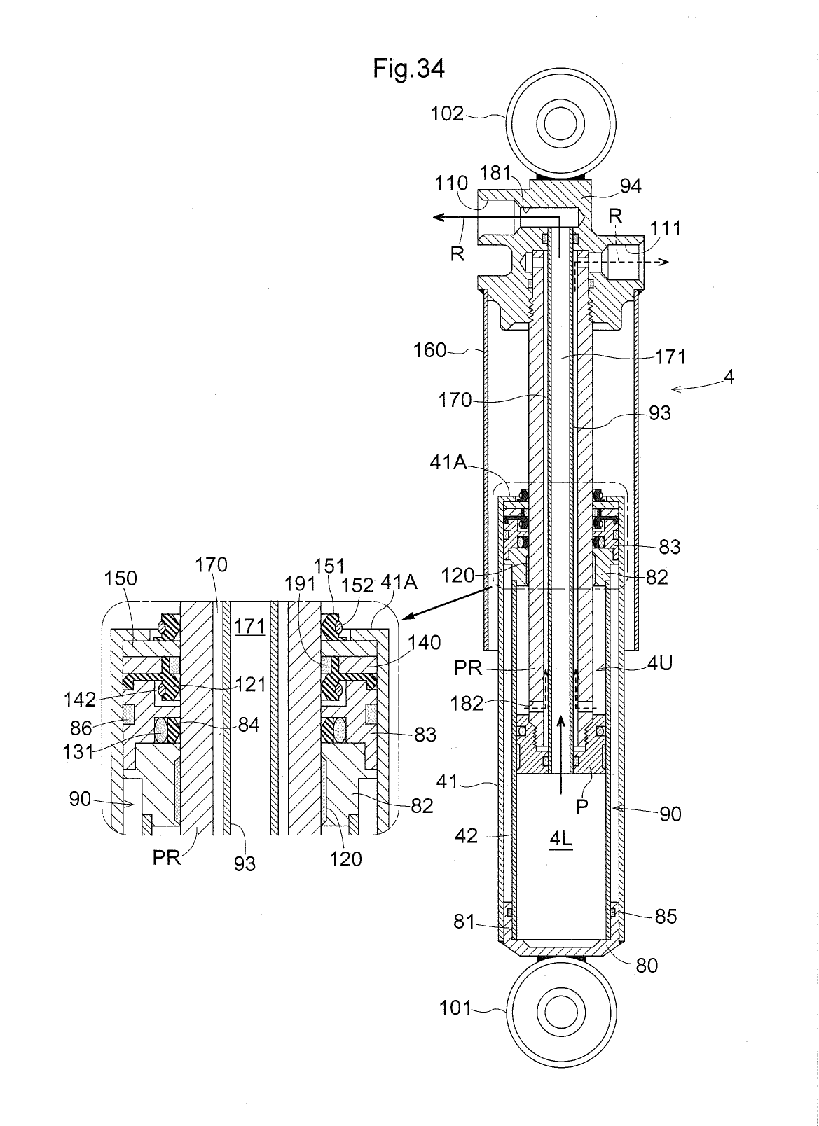

Next, a configuration of a hydraulic cylinder used as the left and right hydraulic cylinders 4 and 5 will be described. The left and right hydraulic cylinders 4 and 5 may be the same hydraulic cylinder. Therefore, an example of the left hydraulic cylinder 4 will now be described. FIG. 34 is a cross-sectional view schematically showing a configuration of the left hydraulic cylinder 4. Note that, in the first to third embodiments, a hydraulic cylinder having a configuration described below is, of course, applicable as the damping force control cylinders 10A and 10B.

The left hydraulic cylinder 4 includes an outer tube 41, an inner tube 42, a piston P, and a piston rod PR. The outer and inner tubes 41 and 42 are formed in the shape of a cylinder. The outer diameter of the inner tube 42 is smaller than the inner diameter of the outer tube 41. The outer and inner tubes 41 and 42 have the same central axis. Therefore, an annular space 90 is formed between the inner circumferential surface of the outer tube 41 and the outer circumferential surface of the inner tube 42.

A lid member 80 is welded to an end in the axial direction of the outer tube 41 to close the opening. An axially extending portion 81 having a cylindrical shape that extends toward the middle in the axial direction of the outer tube 41 is formed inside the lid member 80. The inner tube 42 is fitted into the axially extending portion 81 to be positioned. A seal member 85 is provided in a portion of the inner circumferential surface of the axially extending portion 81 that is in contact with the outer circumferential surface of the inner tube 42. As a result, a liquid-tight structure can be provided at one end in the axial direction of the annular space 90. Here, a fixing member 101 that is used to attach the left hydraulic cylinder 4 to the link member 3 is welded to an outer surface (in the axial direction) of the lid member 80.

Also, a first cap member 82 is fitted into the other end in the axial direction of the inner tube 42, with the outer circumferential surface of the first cap member 82 being in contact with the inner circumferential surface of the outer tube 41, and is positioned with respect to the inner circumferential surface of the outer tube 41. The first cap member 82 is supported by a second cap member 83 from the outside in the axial direction (the opposite side from the fixing member 101). The outer circumferential surface of the second cap member 83 is in contact with the inner circumferential surface of the outer tube 41. A rod seal 84 of Teflon (registered trademark) is provided radially inside the second cap member 83 with an O-ring 131 being interposed therebetween. As a result, while the sliding resistance of the piston rod PR when it is sliding can be reduced, sealing performance can be improved. Also, a seal member 86 is provided on the outer circumferential surface of the second cap member 83. As a result, a liquid-tight space can be provided between the second cap member 83 and the outer tube 41.

Thus, the liquid-tight annular space 90 can be formed. Note that oil or air is enclosed in the annular space 90 in a liquid-tight manner. As a result, the thermal insulation of the left hydraulic cylinder 4 can be improved. Also, the distortion of a sliding surface (outer circumferential surface) of the piston P due to external thrown-up stones can be prevented.

The piston P and the piston rod PR, which have the same central axis, are provided radially inside the inner tube 42, with one end in the axial direction of the piston rod PR being fixed to the piston P. The outer diameter of the piston rod PR is smaller than the inner diameter of the inner tube 42. The outer circumferential surface of the piston rod PR is allowed to slide on inner circumferential surfaces of the first and second cap members 82 and 83. A region surrounded by the inner circumferential surface of the inner tube 42, the piston P, and the lid member 80 corresponds to the lower cylinder chamber 4L.

A cylindrical tube 93 (corresponding to a “tube-shaped member” of the present invention) is provided radially inside the piston rod PR in a concentric manner. A cap 94 is fastened and fixed to the other end of the piston rod PR using a screw. In the cap 94, a port 111 through which the oil R is supplied to and discharged from the upper cylinder chamber 4U, and a port 110 through which the oil R is supplied to and discharged from the lower cylinder chamber 4L, are formed. Also, a fixing member 102 that is used to attach the left hydraulic cylinder 4 to the support member 1B of the vehicle body 9 is welded to the cap 94. Therefore, the ports 110 and 111 can be located away from the fixing member 101, which is located below the ports 110 and 111.

As described above, the piston rod PR is fastened and fixed by the cap 94. Therefore, the fixing member 102 corresponds to a fixing member for the piston rod PR provided thereabove. Therefore, in this embodiment, the ports 110 and 111 can be provided in the fixing member 102 of the piston rod PR.

The piston P is inserted and penetrates into the tube 93 from its one end in the axial direction thereof, which is in communication with the lower cylinder chamber 4L through a space radially inside the tube 93. The space radially inside the tube 93 serves as a lower cylinder chamber fluid path 171 through which the oil R is supplied to and discharged from the lower cylinder chamber 4L. The tube 93, i.e., the lower cylinder chamber fluid path 171, is in communication with the port 110 through a radial fluid path 181 at the other end in the axial direction thereof. A space surrounded by the outer circumferential surface of the tube 93, the inner circumferential surface of the inner tube 42, the piston P, and the first cap member 82, corresponds to the upper cylinder chamber 4U.

An annular space is formed between the outer circumferential surface of the tube 93 and the inner circumferential surface of the piston rod PR. The annular space is in communication with the upper cylinder chamber 4U through a radial fluid path 182 at one end thereof, and is in communication with the port 111 at the other end thereof. Therefore, the annular space serves as an upper cylinder chamber fluid path 170 through which the oil R is supplied and discharged. As described above, in this embodiment, the upper and lower cylinder chamber fluid paths 170 and 171 are provided radially inside the piston rod PR.

The upper and lower cylinder chambers 4U and 4L are filled with the oil R. As the piston P moves in the inner tube 42, the volumes of the upper and lower cylinder chambers 4U and 4L change. The oil R is supplied or discharged through the ports 110 and 111, depending on that change. The piston rod PR moves in the axial direction in association with the motion of the piston P. Therefore, a bush 120 is provided at a position on the first cap member 82 that faces the outer circumferential surface of the piston rod PR.

A small-diameter portion 41A that reduces the inner diameter of the outer tube 41 is formed at an end in the axial direction of the outer tube 41. A disc-shaped iron plate 150 is provided on one side (the side facing the second cap member 83) in the axial direction of the small-diameter portion 41A. The iron plate 150 is positioned by the outer circumferential surface thereof coming into contact with the inner circumferential surface of the outer tube 41. A rubber member 151 that is put on the iron plate 150 is provided radially inside the small-diameter portion 41A. A metal spring 152 that exerts a force on the rubber member 151 radially inward is provided on the outer circumferential surface of the rubber member 151. As a result, the entry of external dust through a portion radially inside the small-diameter portion 41A can be prevented.

A disc-shaped iron plate 140 is provided on an end surface in the axial direction of the iron plate 150 that faces the second cap member 83. The iron plate 140 is positioned by the outer circumferential surface thereof coming into contact with the inner circumferential surface of the outer tube 41. A seal member 121 of rubber is provided on the inner circumferential surface, and an end surface in the axial direction facing the second cap member 83, of the iron plate 140. The seal member 121 extends along the piston rod PR in the axial direction. A metal spring 142 provided radially outside the seal member 121 exerts a force on that extending portion radially inward. Also, a bush 191 of resin is provided radially inside the seal member 121 with the iron plate 140 being provided radially outside the seal member 121. As a result, sealing performance can be improved, particularly in the presence of low pressure, and the oil R can be prevented from leaking from the left hydraulic cylinder 4 along the outer circumferential surface of the piston rod PR. Therefore, the oil R can be prevented from leaking out. With the above configuration, the piston P and the piston rod PR can move together on the same axis.

A cover member 160 is provided on the cap 94, covering at least a portion of the outer circumferential surfaces of the piston rod PR and the outer tube 41. As a result, the outer circumferential surface of the piston rod PR can be protected from dust etc.

### 3. Other Embodiments

In the above-described first to third embodiments, the acceleration detector 30 that detects an acceleration in a direction perpendicular to the vehicle body of the vehicle 1 is provided, and the opening area of the variable valve 11 is adjusted based on the result of the detection performed by the acceleration detector 30. However, the scope of the present invention is not limited to this. Instead of the technique of using the acceleration detector 30, the stroke amount of a wheel may be detected, and based on the result of the detection, the opening area of the variable valve 11 may be adjusted, for example. Of course, other techniques may be used.

In the above-described first to third embodiments, the damping force valve 14 has been illustrated as a mechanical valve. However, the scope of the present invention is not limited to this. An electromagnetic variable valve may be provided for the lower cylinder chamber 10L, similar to the upper cylinder chamber 10U.

In the above-described first to third embodiments, the variable valve 24 is an inflow valve for the accumulator 23. However, the scope of the present invention is not limited to this. A mechanical inflow valve (damping force valve) may, of course, be provided for the accumulator 23. In this case, an orifice is provided in parallel with the mechanical valve (damping force valve) and the check valve 25 so that none of the first and second communication paths 21 and 22 has a negative pressure. As a result, the accumulator 23 can be in communication with each of the first and second communication paths 21 and 22.

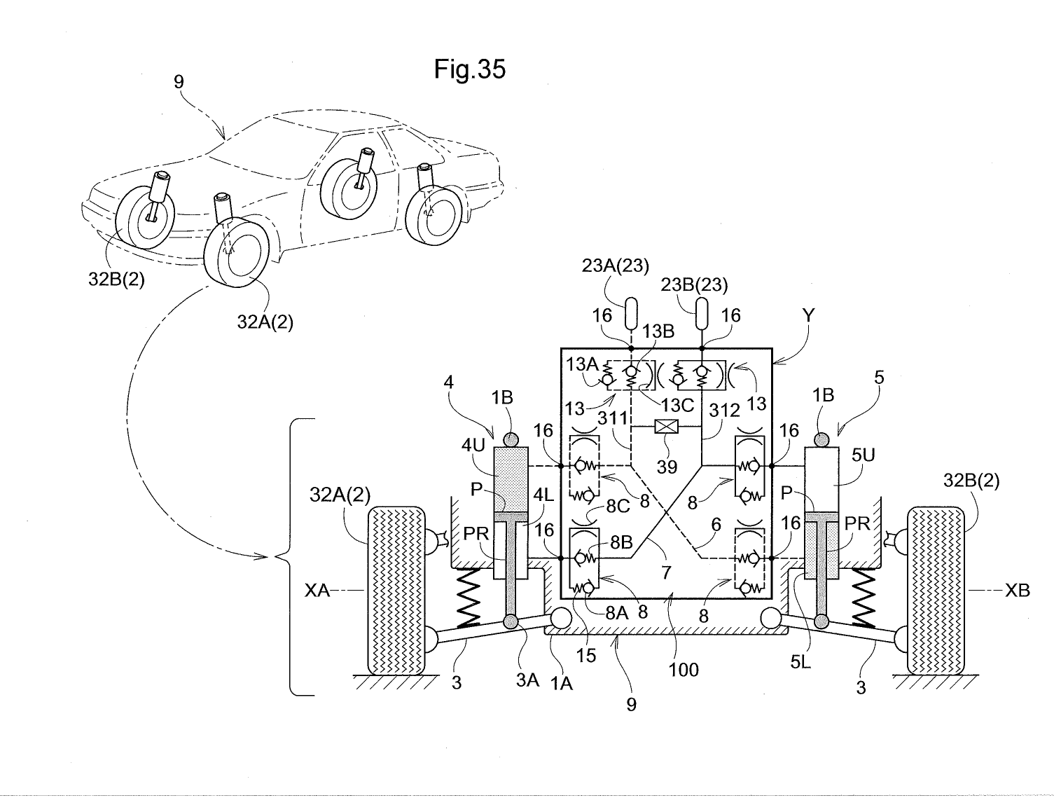

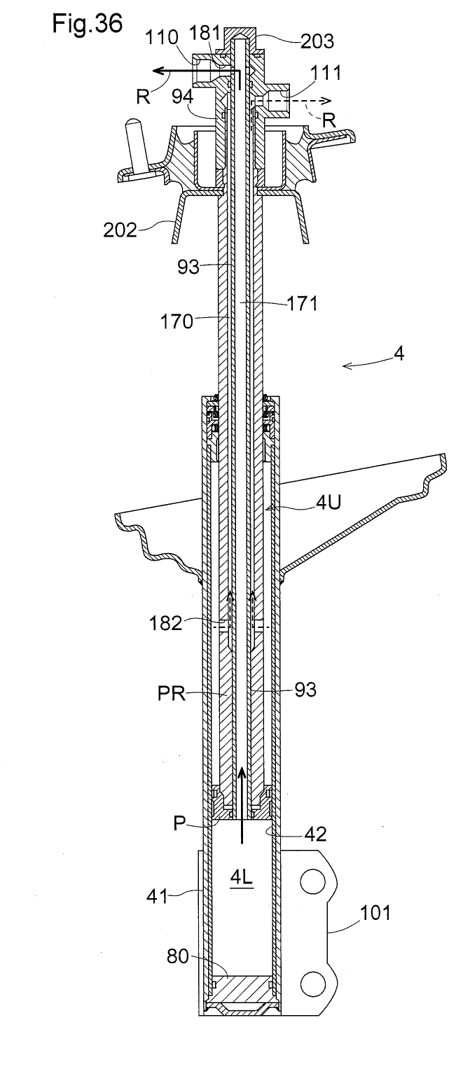

In the above-described fourth embodiment, the differential pressure mechanism 8 and the load mechanism 13 are separated from each other. The scope of the present invention is not limited to this. Alternatively, for example, as shown in FIG. 35, the differential pressure mechanism 8 and the load mechanism 13 may be integrated together into a unit Y. The unit Y has fluid path connection portions 16 corresponding to the respective ports. The unit Y can be easily installed only by connecting fluid paths to the respective corresponding fluid path connection portions 16. By thus unifying the differential pressure mechanism 8 and the load mechanism 13, parts such as valves etc. can be prevented from being exposed, whereby the durability of the parts can be improved, and at the same time, the ease of attaching the unit Y to the vehicle body 9 can be improved, and savings in space can be achieved.

The differential pressure mechanism 8 and the load mechanism 13 are not limited to those described in the above embodiments. Alternatively, a configuration for electrically controlling the open state of a valve may be incorporated in the differential pressure mechanism 8 and the load mechanism 13.

In the above-described embodiments, FIG. 34 schematically shows a configuration of the left hydraulic cylinder 4 (the right hydraulic cylinder 5). However, the scope of the present invention is not limited to this. For example, as shown in FIG. 36, the present invention is, of course, also applicable to a hydraulic cylinder possessed by a MacPherson Strut-type suspension mechanism 50. In this case, the hydraulic cylinder is preferably fastened and fixed to the vehicle body 9 using a bracket 202 instead of the fixing member 102. Also, the cap 94 and the tube 93 can be fastened and fixed together using a nut 203.

In the above-described fourth and fifth embodiments, the suspension system 100 is provided for the front wheels as an example. However, the scope of the present invention is not limited to this. The suspension system 100 is, of course, applicable to the rear wheels or both the front wheels and the rear wheels.

In the above-described fourth to sixth embodiments, the first accumulator valve 13B is a check valve, and the second accumulator valve 13A is a damping force valve. However, the scope of the present invention is not limited to this. Alternatively, the first accumulator valve 13B may, of course, be a damping force valve that exerts a load smaller than that of the damping force valve serving as the second accumulator valve 13A, instead of a check valve.

Here, the suspension system 100 of the fourth to sixth embodiments may include, for a pair of left and right wheels 2 that is at least one of the front and rear wheel pairs: the left hydraulic cylinder 4 interposed between the left wheel 32A and the vehicle body 9; the right hydraulic cylinder 5 interposed between the right wheel 32B and the vehicle body 9; the first fluid path 6 through which the upper cylinder chamber 4U of the left hydraulic cylinder 4 and the lower cylinder chamber 5L of the right hydraulic cylinder 5 are connected together in communication with each other; the second fluid path 7 through which the upper cylinder chamber 5U of the right hydraulic cylinder 5 and the lower cylinder chamber 4L of the left hydraulic cylinder 4 are connected together in communication with each other; the accumulators 23A and 23B that are provided in communication with the first and second fluid paths 6 and 7, respectively; the first accumulator valves 13B that are provided for the accumulators 23A and 23B to discharge the oil R from the accumulators 23A and 23B, respectively; and the second accumulator valves 13A that are provided for the accumulators 23A and 23B to adjust the flow rate of the oil R entering the accumulators 23A and 23B, respectively, thereby exerting on the oil R a load that is greater than that which the first accumulator valve 13B exerts on the oil R.

With the above configuration, when the vehicle body 9 rolls, the oil R flowing out of the left cylinder chamber and the oil R flowing out of the right cylinder chamber pass together through the second accumulator valve 13A, resulting in a great resisting pressure. As a result, a significant damping effect acts on the hydraulic cylinders 4 and 5, whereby the roll of the vehicle body 9 can be reduced, and therefore, sufficient driving stability is more easily ensured. Because of the stabilizer function of this configuration, the conventional stabilizer bar can be removed.

Also, a differential pressure mechanism 8 may be provided for each of the ports 110 and 111 of each cylinder chamber, to provide a difference between input and output pressures of the oil R for each of the ports 110 and 111.

With this configuration, when the vehicle body 9 bounces, the differential pressure mechanism 8 can operate to exert a resisting pressure that is smaller than that during roll, on the oil R passing through each of the ports 110 and 111 in a predetermined direction. As a result, the bounce of the vehicle body 9 can be damped by the damping effects of the hydraulic cylinders 4 and 5, whereby good ride quality can be obtained. With this configuration, the absorber function can be imparted to the differential pressure mechanism 8, and therefore, the conventional absorber can be removed or the size of the conventional absorber can be reduced. As described above, the differential pressure mechanism 8 also has the stabilizer function, and therefore, the conventional stabilizer bar can be removed. Thus, the structure around the wheel 2 can be simplified.

Also, when the vehicle body 9 rolls, the lower cylinder chamber 4L (5L) of the hydraulic cylinder 4 (5) on one side, and the upper cylinder chamber 5U (4U) of the hydraulic cylinder 5 (4) on the other side, which is in communication with the chamber 4L (5L), simultaneously contract to reduce their volumes, and therefore, the oil R is pushed out of both of the cylinder chambers and is moved into the accumulator 23B (23A). In the present invention, the second accumulator valve 13A is provided that exerts a load on the oil R when the oil R enters the accumulator 23B (23A). Therefore, when the oil R moves in the above manner, the second accumulator valve 13A and the differential pressure mechanisms 8 corresponding to the ports 110 and 111 of the cylinder can generate flow resistance. As a result, the effect of damping the roll of the vehicle body 9 can be further enhanced. Thus, even when a complicated mechanical mechanism or control mechanism is not provided, a passive system can be used to generate a damping force effective against the roll and bounce of the vehicle body 9, whereby sufficient driving stability and good ride quality can be simultaneously ensured.

Also, the differential pressure mechanism 8 may be configured so that a set pressure that is generated when the oil R is discharged from the cylinder chamber is set to be higher than a set pressure that is generated when the oil R enters the cylinder chamber.

With this configuration, a damping force can be increased when the oil R is discharged from the cylinder chamber, and the oil R can smoothly enter the cylinder chamber. Therefore, a damping force effective against the roll and bounce of the vehicle body 9 can be effectively generated.

Also, the differential pressure mechanism 8 may include the orifice 8C, the check valve 8A, and the damping force valve 8B that exerts a load on the oil R when the oil R is discharged from the cylinder chamber, to generate a damping force.

With this configuration, by effectively utilizing the resistance characteristics of each of the orifice 8C and the damping force valve 8B, damping force characteristics effective against a force input from a road surface can be generated. Therefore, for example, when the speed of the input force acting on the hydraulic cylinder is low, the shock can be mainly damped by the orifice 8C. When the speed of the input force is high, the shock can be damped by the damping force valve 8B in addition to the orifice 8C. As a result, the input force from a road surface acting on the wheel 2 can be suitably damped no matter how large or small the input force is, whereby driving stability and ride quality can be simultaneously improved.

Also, the differential pressure mechanism 8, and the load mechanism 13 including the first and second accumulator valves 13B and 13A, may be unified.

With this characteristic configuration, the unification of the differential pressure mechanism 8 and the load mechanism 13 can reduce the number of parts such as pipes etc. and improve the ease of attachment to the vehicle body 9, and at the same time, achieve savings in space. Also, parts such as valves etc. included in the differential pressure mechanism 8 and the load mechanism 13 can be easily prevented from being exposed, whereby the durability of the parts can be improved.

Also, the second accumulator valve 13A may be configured to exert on the oil R a load that is greater than that which the first accumulator valve 13B for the accumulator 23B (23A) provided on the opposite side from the accumulator 23A (23B) for which the second accumulator valve 13A is provided.

With this configuration, the damper effect acting on the hydraulic cylinder can be enhanced, whereby the roll of the vehicle body 9 can be reduced, and therefore, sufficient driving stability can be more easily ensured.

Also, the suspension mechanism 50 from which the wheel 2 hangs may be provided.

With this configuration, the roll of the vehicle 1 can be further damped, and the roll stiffness of the vehicle 1 can be increased, etc. In addition, damping forces against roll, bounce, etc. can be more flexibly adjusted. If the suspension mechanism 50 is used in combination with an absorber, and functions are divided or shared between the suspension mechanism 50 and the absorber, the size of the suspension system 100 can be reduced, and the flexibility of mounting the suspension system 100 can be improved.

Although the reference characters are given above for ease of comparison with the drawings, the reference characters are not intended to limit the present invention to the configurations shown in the drawings. Various embodiments can be made without departing from the scope of the present invention.

### INDUSTRIAL APPLICABILITY

The present invention is applicable to suspension systems that are used to improve the ride quality and maneuvering stability of vehicles.

### DESCRIPTION OF REFERENCE SIGNS

1: VEHICLE
2: WHEEL
9: VEHICLE BODY
4: LEFT HYDRAULIC CYLINDER
4L: LOWER CYLINDER CHAMBER
4U: UPPER CYLINDER CHAMBER
5: RIGHT HYDRAULIC CYLINDER
5L: LOWER CYLINDER CHAMBER
5U: UPPER CYLINDER CHAMBER
10: DAMPING FORCE CONTROL CYLINDER
10A: DAMPING FORCE CONTROL CYLINDER ON ONE SIDE
10B: DAMPING FORCE CONTROL CYLINDER ON OTHER SIDE
10U: UPPER CYLINDER CHAMBER
10L: LOWER CYLINDER CHAMBER
11: VARIABLE VALVE
21: FIRST COMMUNICATION PATH
22: SECOND COMMUNICATION PATH
23: ACCUMULATOR (OIL RECEPTACLE)
24: VARIABLE VALVE
25: CHECK VALVE
30: ACCELERATION DETECTOR
32A: LEFT WHEEL
32B: RIGHT WHEEL
93: TUBE (TUBE-SHAPED MEMBER)
100: SUSPENSION SYSTEM
101: FIXING MEMBER
102: FIXING MEMBER
110: PORT
111: PORT
170: UPPER CYLINDER CHAMBER FLUID PATH
171: LOWER CYLINDER CHAMBER FLUID PATH
PR: ROD
R: OIL

1. A suspension system comprising:
damping force control cylinders each including an upper cylinder chamber whose volume increases during expansion and decreases during contraction, a lower cylinder chamber whose volume decreases during expansion and increases during contraction, and a variable valve that adjusts the flow rate of oil flowing out of the lower cylinder chamber based on the result of detection performed by a detector that detects a physical quantity of a vehicle, wherein the damping force control cylinders are incorporated in a pair of wheels of a plurality of wheels included in the vehicle;
a first communication path through which the upper cylinder chamber of one of the damping force control cylinders is in communication with the lower cylinder chamber of the other of the damping force control cylinders;
a second communication path through which the lower cylinder chamber of the one damping force control cylinder is in communication with the upper cylinder chamber of the other damping force control cylinder;
a pair of accumulators that are provided in the first and second communication paths, respectively, and hold and discharge oil of the first and second communication paths, depending on operations of the damping force control cylinders;
a variable valve that limits the flow rate of oil flowing into at least one of the accumulators; and
a check valve provided in parallel with the variable valve.

2. The suspension system according to claim 1, comprising:
an acceleration detector that detects an acceleration in a direction perpendicular to a vehicle body of the vehicle,
wherein the variable valve adjusts the flow rate of the oil based on the result of the detection performed by the acceleration detector.

3. (canceled)

4. (canceled)

5. (canceled)

6. The suspension system according to claim 1, wherein
the pair of wheels are a left wheel and a right wheel that face each other in the lateral direction of the vehicle.

7. The suspension system according to claim 1, wherein
the pair of wheels are a front wheel and a rear wheel that are arranged in the longitudinal direction of the vehicle.

8. The suspension system according to claim 6, wherein
a left hydraulic cylinder interposed between the left wheel and a vehicle body, and a right hydraulic cylinder interposed between the right wheel and the vehicle body, have ports through which oil is supplied to and discharged from the upper and lower cylinder chambers, the ports being separated from a lower fixing member.

9. The suspension system according to claim 1, wherein
a port through which oil of the upper cylinder chamber is supplied and discharged, and a port through which oil of the lower cylinder chamber is supplied and discharged, are provided in an upper fixing member of a rod.

10. The suspension system according to claim 9, wherein
an upper cylinder chamber fluid path through which oil of the upper cylinder chamber is supplied and discharged, and a lower cylinder chamber fluid path through which oil of the lower cylinder chamber is supplied and discharged, are provided radially inside the rod.

11. The suspension system according to claim 10, wherein
a tube-shaped member is provided radially inside the rod, the tube-shaped member and the rod having the same central axis, the lower cylinder chamber fluid path is formed radially inside the tube-shaped member, and the upper cylinder chamber fluid path is formed between the inner circumferential surface of the rod and the outer circumferential surface of the tube-shaped member.
